(19) United States
(12) Patent Application Publication
(10) Pub. No.: US 2015/0119070 A1
(43) Pub. Date: Apr. 30, 2015

(54) System, Method and Apparatus for Device Management and Tracking

(71) Applicant: eTrak Corporation, Dallas, TX (US)

(72) Inventors: John E. Harris, Dallas, TX (US); Sang Pheng, Arlington, TX (US)

(21) Appl. No.: 14/315,120

(22) Filed: Jun. 25, 2014

Related U.S. Application Data
(60) Provisional application No. 61/895,277, filed on Oct. 24, 2013.

(51) Int. Cl. H04W 64/00; H04W 52/02

(52) U.S. Cl. CPC H04W 64/00; H04W 52/0209
USPC 455/456.1

(57) ABSTRACT

Embodiments of the present disclosure provide systems, apparatus and methods for device management and tracking. Embodiments further disclose systems, apparatus and methods for conserving battery power to extend the operational life of the device. Tracking features may include redundant elements or operations for determining a device's movement or location. Such redundant elements or operations may be prioritized based upon power consumption rates associated with the element or operation. System features may include management controls for tracking, alerts and operations. The management controls may be operational through monitoring devices, web portals or other remote devices.

### CROSS-REFERENCE TO RELATED APPLICATION

This application claims the benefit of priority from provisional application No. 61/895,277 filed on Oct. 24, 2013, which is incorporated herein by reference.

### FIELD OF THE DISCLOSURE

The invention relates generally to the field of electronic device management and tracking. More specifically, some embodiments relate to electronic location tracking devices and the power management thereof.

### BACKGROUND

Electronic device tracking systems are often based upon one form of triangulation using an electronic signal. For example, global positioning system (“GPS”) tracking utilize signals from multiple satellites to determine the distance from each satellite to the GPS device and calculate a location on the earth based upon multiple distances. Some GPS systems further rely on additional devices or systems to improve the accuracy of the determined location. For example, a GPS device located at a known location may be used to evaluate propagation errors (or other errors) associated with one or more signals from the satellites and share corrective calculations with associated mobile GPS devices. The tracking system using GPS would evaluate the GPS derived location on a periodic basis and track the movement of the device.

Other triangulation systems may include cellular systems, radio systems, and other systems which utilize signals associated with known locations to determine the current location of a device. The location is then updated periodically to operate as a tracking system.

These devices often drain power quickly through the repetitive collection and analysis of signals as well as communications necessary to improve the accuracy of the determined location. Accordingly, they require large batteries and/or regular charging to operate as mobile tracking devices.

One system for location determination is provided by ZOS Communications for location based marketing. The ZOS system consists of a software module for use in a mobile phone having GPS and Wi-Fi sensors. The software collects information from the GPS and Wi-Fi sensors as well as cellular identification information and sends the information to a remote server. The remote server computes a fixed location based upon the aGPS, Wi-Fi and cellular identification information received from the mobile phone using the software. The remote server may send location specific information, such as advertisements, to the mobile phone based upon the determined location of the mobile phone. The software allows for a user to control the time periods between location updates, but does not provide for the management the independent operations of the GPS and Wi-Fi sensors or any other sensors in the mobile phone. Accordingly, the power consumption during the location update process remains high as the sensors and communication components each operate to determine independent information for further analysis.

### SUMMARY

The present disclosure relates to an electronic device management and tracking system, method and apparatus. The system may incorporate networked devices including one or more tracking components, existing communication infrastructures, servers, databases and/or computer components. The one or more components may incorporate hardware, firmware and/or software to manage the device operation and tracking in order to reduce overall power consumption while maintaining a sufficient level of accuracy. Some components may incorporate additional device management interfaces and tools.

Some embodiments of the present disclosure provide for an apparatus operable to communicate over a plurality of communication networks such as the cellular network, a Wi-Fi network, a satellite network and the Internet. In addition, the apparatus may operate with a location determination system such as GPS, LORAN, aGPS and other location determination systems. The apparatus may further be configured to utilize a structured order of controls and location determination mechanisms to track the apparatus and maintain a reduced power usage profile. The apparatus may further include hardware, software and/or firmware controls designed to maximize battery life.

Some embodiments of a tracking apparatus may operate to periodically determine the apparatus's location by evaluating whether the apparatus is located within a Wi-Fi and, if so, determining the identity of the Wi-Fi. Based upon the identity of the Wi-Fi, the apparatus determines whether or not the device has changed locations. If the device has not changed locations, the apparatus maintains its association with the prior location and stops operation until the next periodic update. If the device has changed locations, the apparatus will determine the current location in a manner to minimize power consumption. For example, the apparatus may internally compare the identity of the Wi-Fi to known Wi-Fi identities and locations. If the Wi-Fi is not in the internal database, the apparatus may determine the location of the Wi-Fi based upon an external communication, such as cellular communication, with a database containing the Wi-Fi location information. If the database includes the Wi-Fi location information, the apparatus updates its location and Wi-Fi information and stops operation until the next periodic update. If the database does not have the location information associated with the Wi-Fi, the apparatus uses a location determining system, such as aGPS, to identify the current location and updates its location and Wi-Fi information and the database to associate the determined location with the identified Wi-Fi. The apparatus then stops operation until the next periodic update.

Some embodiments may include a networked management and monitoring component. For example, the networked management and monitoring component may be associated with a tracking apparatus and an output device, such as a monitor. The user of the networked management and monitoring component may use the monitor to observe the location, history and/or movement of the tracking apparatus. In some embodiments, a user interface associated with the networked management and monitoring component may be used to manage the tracking apparatus. In some embodiments, the networked management and monitoring component may be a mobile device operating application software.

Some embodiments include a system having a plurality of tracking apparatuses associated with a networked management and monitoring component. The system may be associated with group tracking. For example, each tracking apparatus may be associated with a person with medical need to be tracked, such as an Alzheimer patient, who may wonder away from the proper facility. Some embodiments may be associated with a series of items to be tracked, such as railcars.

Some embodiments of the apparatus include additional features, such as a panic button, an operational indicator, and/or an attachment component to facilitate attaching the apparatus to another item.

In some embodiments, the system utilizes one or more zones and evaluates whether the apparatus has been removed from the selected zone. In some embodiments, the system further includes an alert system, whereby a monitoring device may receive an alert based upon a threshold activity, such as the apparatus leaving a selected area.

In some embodiments, the tracking device may be integrated with another device. For example, the tracking device may be integrated into the housing of larger electronic equipment, such as computers, servers, electronic test equipment and other items. As another example, the tracking device may be integrated into other items such as clothing, luggage, and purses.

### A BRIEF DESCRIPTION OF THE DRAWINGS

Embodiments will now be described, by way of example only, with references to the accompanying drawings in which:

FIG. 1A is a drawing of an embodiment of a system of the present disclosure;

FIG. 1B is a drawing of another embodiment of a system of the present disclosure;

FIG. 2 is a flowchart depicting an embodiment of a process of the present disclosure;

FIG. 3 is a drawing of an apparatus of the present disclosure;

FIG. 4 is an illustration of a map depicting elements of the present disclosure;

FIG. 5 is an embodiment of a mobile device depicting an operation screen associated with the present disclosure;

FIG. 6 is an embodiment of a mobile device depicting another operation screen associated with the present disclosure;

FIG. 7 is an embodiment of a mobile device depicting another operation screen associated with the present disclosure;

FIG. 8 is an embodiment of a mobile device depicting another operation screen associated with the present disclosure;

FIG. 9 is an embodiment of a mobile device depicting another operation screen associated with the present disclosure;

FIG. 10 is an embodiment of a mobile device depicting another operation screen associated with the present disclosure;

FIG. 11 is an embodiment of a mobile device depicting another operation screen associated with the present disclosure;

FIG. 12 is an embodiment of a mobile device depicting another operation screen associated with the present disclosure;

FIG. 13 is an embodiment of another mobile device depicting a screen associated with the present disclosure;

FIG. 14 is an embodiment of another mobile device depicting another screen associated with the present disclosure;

FIG. 15 is an embodiment of another mobile device depicting another screen associated with the present disclosure;

FIG. 16 is an embodiment of another mobile device depicting another screen associated with the present disclosure; and

FIG. 17 is an embodiment of another mobile device depicting another screen associated with the present disclosure.

### DETAILED DESCRIPTION

While this invention may be embodied in many different forms, there will herein be described in detail preferred embodiments of the invention with the understanding that the present disclosure is to be considered as an exemplification of the principles of the invention and is not intended to limit the broad aspects of the invention to the embodiments illustrated. It will be understood that the invention may be embodied in other specific forms without departing from the spirit or central characteristics thereof. The present embodiments, therefore, are to be considered in all respects as illustrative and not restrictive, and the invention is not to be limited to the details given herein.

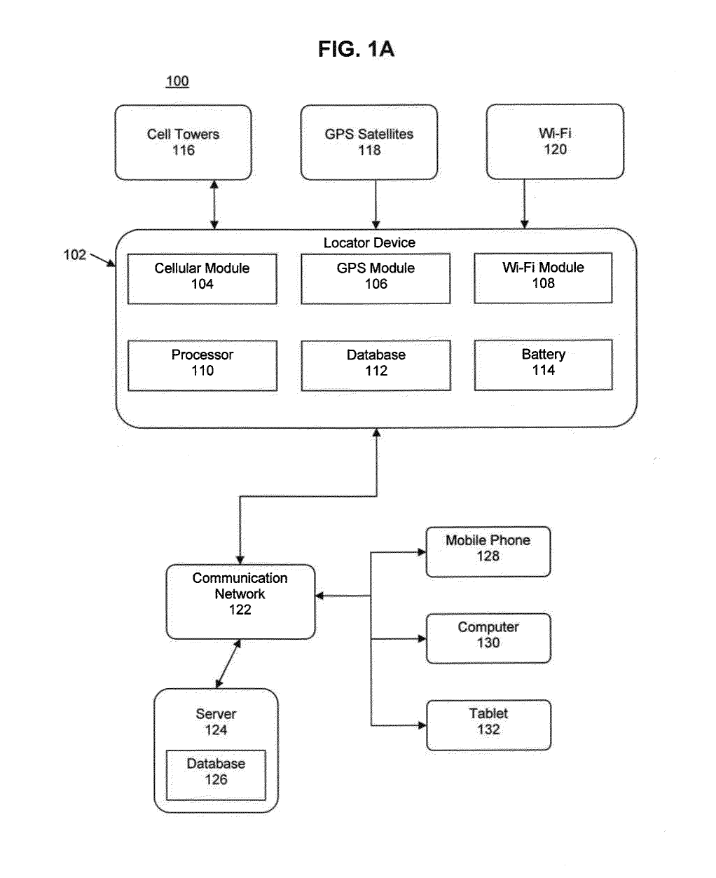

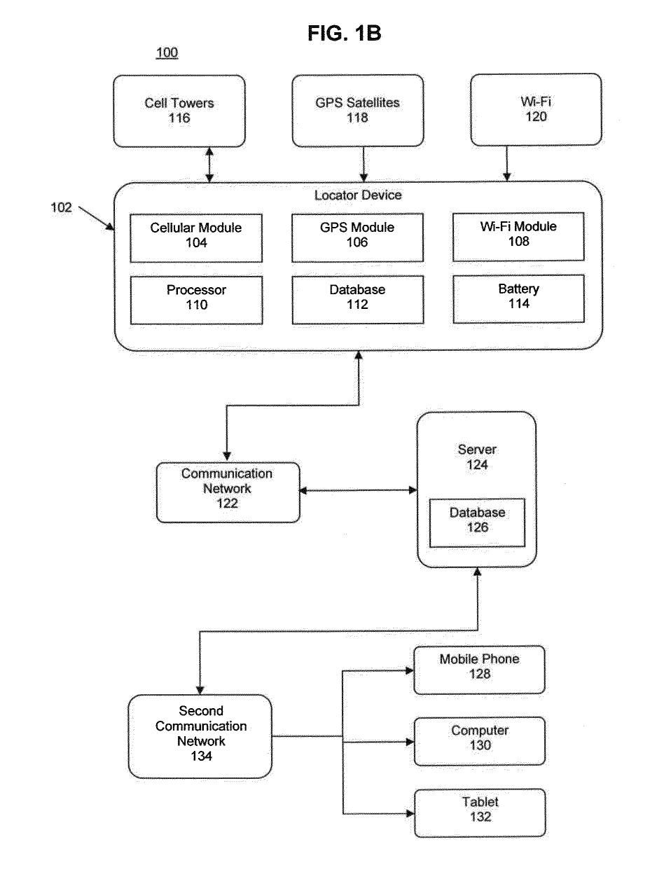

FIG. 1A depicts a system 100 of networked components. The system 100 includes a locator device 102 which may operate to determine the location of the device utilizing one or more locator mechanisms. In some embodiments, the system 100 includes a plurality of locator devices 102. In this embodiment, the locator device 102 includes a cellular module 104, a GPS module 106, a Wi-Fi module 108, a processor 110, a database 112 and a battery 114. The locator device 102 may also incorporate additional operational components such as additional storage, communication components, and other components. In some embodiments, the location determination is based upon operation of the cellular module 104, the GPS module 106 and/or the Wi-Fi module 108.

The cellular module 104 facilitates communication with cell towers 116 and the cellular network. During location determination processes, as discussed further herein, the communication with cellular towers 116 may be used to determine the location of the locator device 102. For example, the location determination process may utilize the identity of the cell tower 116 to which the locator device 102 is operationally connected. For another example, the location determination process may utilize communication with multiple cell towers 116 to triangulate the location of the locator device 102.

The GPS module 106 is operable to receive the GPS signals received from GPS satellites 118. In some embodiments, the GPS module 106 may also include analysis components to evaluate the GPS signals and determine the location of the locator device 102. In some embodiments, the locator device 102 transmits the ephemeris information and/or other information received by the GPS module 106 to another device or system for analysis. For example, the locator device 102 may transmit the information over cellular communication to the cell tower 116 which may analyze the information and return information to the locator device 102 which indicates the location of the locator device 102. In some embodiments, the cell tower 116 may be associated with additional location information which may be incorporated into the analysis to improve the location determination. For example, the cell tower 116 may facilitate the implementation of an assisted GPS (aGPS) system. Such a system may improve the time to acquire the GPS satellites, the accuracy of a location determination, and/or other improvements as well.

The Wi-Fi module 108 may communicate with a Wi-Fi 120. In some embodiments, the Wi-Fi module 108 is configured only to receive Wi-Fi signals and not to transmit over the Wi-Fi network. In some embodiments, the Wi-Fi module 108 may be used to transmit and receive signals over the Wi-Fi 120. In some embodiments, the locator device 102 may access a communication network through transmissions via stationary and/or mobile Wi-Fi sources. When used for determining the location of the locator device 102, the Wi-Fi module 102 may receive and identify the signal from Wi-Fi 120 and/or additional Wi-Fi sources. The processor 110 may access database 112 to determine if the identified Wi-Fi 120 (and others) are associated with a known location. If the Wi-Fi 120 is associated with a given location, the identification of the signal from Wi-Fi 120 may be used to associate the locator device 102 with the given location for the Wi-Fi 120 source. In some embodiments, the Wi-Fi module 108 may be used to transmit signals over a Wi-Fi communication.

In some embodiments, additional wireless communication modules or functions may be supported, such as Bluetooth® communication, ZigBee® communication, radio communication in whitespace frequencies, Infra Red communication, and/or other radio and light communications. For example, the locator device 102 may include one or more radio frequency identification (“RFID”) components which may be utilized to determine the current location of the device and/or whether the device has changed locations. For another example, the locator device 102 may include a Bluetooth® module which may communicate with other Bluetooth® devices, such as fixed location Bluetooth® devices and/or selected mobile Bluetooth® devices.

Some embodiments of the locator device 102 may include one or more communication modules and/or signal acquisition modules for use in determining the location of the locator device 102. The various modules may provide a variety of communication ranges, such as near field communications (e.g. Bluetooth®, Wi-Fi, etc.), broader communications (e.g. cellular, etc.) and global communications (e.g. satellite, etc.). In addition, the various modules may provide a variety of power consumption profiles whereby the locator device 102 may prioritize module operations based upon the power consumption profiles. One skilled in the art will recognize that the battery conservation system discussed herein relating to the prioritization of modules based in part upon power consumption profiles may be applicable to components and/or modules unrelated to location determination and/or communication operations. For example, a device may include a series of output mechanisms with different power consumption profiles, whereby the system may prioritize outputs in part based upon the power consumption profile for each output mechanism. In some embodiments, the battery conservation system is applied to redundant elements and/or features of a device.

Embodiments of the battery 114 may include a lithium-ion battery, a solid state battery or other battery types. In some embodiments, the battery 114 is a rechargeable battery and the locator device 102 includes features to facilitate the recharging of the battery 114. For example, the locator device 102 may include firmware which controls the conditions associated with recharging the battery 114. In some embodiments, the recharging features are designed to lengthen the life of the battery 114. The locator device 102 may be designed with one or more charging components, such as cord connections, exposed terminals, induction charging components and/or other charging components, which correspond to different charging processes and apparatuses.

In some embodiment, the locator device 102 includes internal and/or integrated battery charging components. For example, the locator device 102 may include power generation components which harness natural energy such as solar energy, kinetic energy, thermal energy or other natural energies. Embodiments utilizing one or more power generation components may be suited for select uses and not all versions of the locator device 102. For example, the locator device 102 incorporating a kinetic energy harness may be used for trains, trucks and trailers, cars, tractors and/or other vehicles or objects which regularly are in motion. In some embodiments, the size, shape, structure and/or other aspect of the locator device 102 may vary based upon the incorporated components. In some embodiments, the power generation components are designed to lengthen the period between charges using an external recharging component.

In some embodiment, the locator device 102 includes a backup battery. In some embodiments, the backup battery which may serve as part of an emergency backup system. The emergency system may operate on a different process to further minimize battery usage and ensure a charge remains when necessary. In some embodiments, the battery backup may be an external battery.

In some embodiments, the locator device 102 may be used in a device, vehicle and/or other object which is associated with another power source. In such embodiments, the locator device 102 may be designed to connect to the power source of the other object. For example, the locator device 102 may be connected to the vehicles electronic components to leverage the vehicle battery to maintain the charge of its internal battery 114. In some embodiments, the internal battery 114 may be removed, with the locator device 102 instead relying upon the external power source. In some embodiments, the internal battery 114 provides a backup system for when the external power source is unavailable and/or insufficient. For example, a thief may remove a car battery to shut down systems internal to the vehicle. If the vehicle power source is unavailable, the locator device 102 operates on its own battery 114 and continues to provide tracking information. In some embodiments, the locator device 102 may be designed to integrate with the vehicle electronics at any location allowing the locator device 102 to remain hidden better than devices which are located in a common set of locations.

In some embodiments, the locator device 102 may be designed, sized, shaped and/or structured for specific uses. For example, the locator device 102 for monitoring train cars may incorporate a larger battery with a high capacity and operate a larger interval between location determinations to extend the battery life beyond that of a smaller version designed to be held by a pet or person. In addition, the components may be designed to withstand different environmental characteristics, such as large temperature variations, high vibration characteristics, weather characteristics and/or other characteristics. In addition, specific components may be added or removed based upon the anticipated use. For example, the locator devices 102 for a train system may include an RFID chip in the device which may be used to register the specific locator device 102 with a train yard having RFID components and readers. In addition, the locator device 102 may include a short range communication component which may be used to activate the system when someone is looking to locate the specific rail car associated with the locator device 102.

In some embodiments, the locator device 102 may be intended to be conspicuous, overt, or otherwise apparent. For example, a panic button in the locator device 102 associated with a child or elderly person may be used by a third party when an injury occurs in order to call help to their location. For another example, the locator device 102 on a vehicle, electronic equipment or other valuable may act as a deterrent from theft. In some embodiments, the locator device 102 is designed to be inconspicuous and/or hidden. The locator device 102 may be integrated into a backpack, phone, laptop, clothing, shoes, wearable accessories (such as a belt) or other item whereby the inclusion of the locator device 102 is not readily apparent. For example, a mobile phone may independently include one or more components of the locator device 102 in the same housing such that the location determination process may operate independently of the controls for the mobile phone. In some such embodiments, the locator device 102 and the mobile phone may share certain components while independently utilizing the components as appropriate. For example, the cellular module 104, GPS module 106 and Wi-Fi Module 108 may be shared components while the combined device also includes an independent processor 110, database 112 and battery 114 for the locator device 102. In some embodiments, the locator device 102 may be available as an accessory component to another item. For example, the locator device 102 may be integrated into a protective case for a mobile phone. In such embodiments, the locator device 102 may be designed to leverage one or more components of the associated device. The locator device 102 may also be designed to facilitate charging of other electronic devices and concurrently charging the locator device 102. In some embodiments, disassociation between the locator device 102 and the other item (such as the mobile phone) may trigger the system to provide an alert to a monitoring device.

In some embodiments, the locator device 102 may be associated with personal information, medical information and/or other information which may be needed during an emergency. In some embodiments, the locator device 102 may include a barcode or identification which medical personnel may use to access medical information through a secure system. In some embodiments, the locator device 102 may include a control to facilitate communication with a monitoring device for use by emergency personnel.

The locator device 102 in system 100 is operable to communicate using the communication network 122. In some embodiments, the locator device 102 uses one of the location derivation modules, such as the cellular module 104 and/or the Wi-Fi module 108, to facilitate the communication over the communication network 122. In some embodiments, the locator device 102 may include one or more additional communication components to facilitate communication over the communication network 122. In some embodiments, the communication component utilized to facilitate communication network 122 may be selected based upon a power consumption profile.

The communication network 122 may comprise one or more communication networks to facilitate communication with the locator device 102. For example, the communication network 122 may comprise a Wi-Fi communication which facilitates a broadband Internet connection. The communication network 122 may comprise one or more communication standards such as Internet communication, cellular communication, satellite communication, Bluetooth® communication, radio communication and/or other communication standards.

In some embodiments, the communication network 122 facilitates communication with a server 124. One skilled in the art will recognize that the server 124 may be any computing device capable of the operations described herein and remain within the scope and spirit of the present disclosure. In some embodiments, system 100 may include multiple servers 124. In some embodiments, the server 124 is in operable association with a database 126. One skilled in the art will recognize that the database 126 may be any electronic storage device capable of the operations described herein and remain within the scope and spirit of the present disclosure. In some embodiments, system 100 may include multiple databases 126.

In some embodiments, the server 124 and the database 126 may be utilized during the location determination process. For example, the database 126 may included data associated various Wi-Fi identifications (such as Wi-Fi 120) with known locations which may be utilized to associate the locator device 102 with a location based upon the identification of Wi-Fi 120.

In some embodiments, the server 124 and database 126 may be utilized to track and/or analyze location information associated with the locator device 102. For example, the server 126 and database 126 may collect and store data regarding one or more of the locator devices 102. The data may include locations, times associated with locations, operation of a user interface on the locator device 102, battery status, usage patterns and/or other data. In some embodiments, the server 124 may analyze patterns of conduct to determine whether the current location is consistent with the patterns of device movement.

In some embodiments, the server 124 may create alerts based upon one or more characteristics of the locator device 102 operations and/or location information. For example, the server 124 may operate to analyze whether the location of the locator device 102 is within a given threshold of a selected location, and create an alert with the locator device 102 is beyond the threshold. For another example, the server 124 may monitor the charge of the battery 114 and create an alert based upon the reduction in charge below a threshold. In some embodiments, the server 124 may develop a movement profile associated with the locator device 102 and create an alert when the locator device 102 is located in a location that is inconsistent with the movement profile.

In some embodiments, the server 124 creates an alert and provides the alert over the communication network 122 to one or more networked monitoring devices, such as mobile phone 128, computer 130, tablet 132 and/or any other monitoring device. In some embodiments, the server 124 only provides the alert to a selected monitoring device which is associated with the specific locator device 102. In some embodiments, the database 126 will maintain the associations between specific locator device 102 and specific networked monitoring devices. In some embodiments, the associations may further depend upon additional characteristics accounted for by the server 124, the database 126 and/or another component of system 100. For example, the appropriate monitoring devices may be determined based upon time, location of the monitoring device, location of the locator device 102, the type of alert, and/or other characteristics. In some embodiments, the alert may include a map showing directions from a specific networked monitoring device to a specific locator device 102.

In some embodiments, the server 124 may be associated with a web interface to facilitate access to information associated with the locator device 102 through any Internet access device. In some embodiments, the web interface may also facilitate management of the locator device 102 and/or alert controls and thresholds. For example, the web interface may facilitate management of the operational characteristics of the locator device 102 such as the time schedule or period in which the locator device 102 will determine its location. For another example, the web interface may facilitate management of the alert characteristics such as defining one or more zones, whereby an alert is provided any time the locator device 102 enters and/or exits the zone. In some embodiments, the web interface may be used to associate multiple locator devices 102, monitoring devices and/or other associated devices. For example, parents may provide a locator device 102 to each of their kids and associate the multiple locator devices 102 with each parent's mobile phone 128 such that the server 124 will not send an alert if the locator devices 102 are within a specified distance from one or both of the parents' mobile phones 128. In some embodiments, the locator devices 102 may be associated with other devices without using the web interface. For example, the locator device 102 may be paired with a vehicles' Bluetooth® system directly. As another example, the locator device 102 may be paired with a tablet 132 using a direct Wi-Fi connection. Application software may allow the pairing process to establish a mobile zone around the paired device in which alerts will not be provided.

In some embodiments, the mobile phone 128, computer 130 and tablet 132 may utilize an application or other software to directly monitor and/or control the operations and/or outputs of the locator device 102. In other embodiments, the mobile phone 128, computer 130 and tablet 132 may utilize the web interface associated with the server 124 to monitor, control and/or manage the locator device 102.

In some embodiments, the communication network 122 facilitates communication directly between one or more networked monitoring devices including the mobile phone 128, the computer 130 and the tablet 132. In such an embodiment, the operations of the server 124 and/or database 126 may be performed by one or more of the locator devices 102 and/or networked monitoring devices 128, 130 and 132.

In some embodiments, the various components and interfaces may include one or more security measures. For example, the web interface provided by the server 124 may include a password access system. In some embodiments, the server 124, the locator device 102 and/or the networked monitoring devices 128, 130 and 132 may require a series of identification and access protocols, such as device identification and associations electronically confirmed in conjunction with a password protection system. One skilled in the art will recognize that a variety of security measures and standards may be employed to protect access and/or control over the system 100.

FIG. 1B depicts an alternative embodiment of the system 100. As shown and discussed above, the system 100 includes one or more of the locator devices 102. In this embodiment, the locator devices 102 include the cellular module 104, the GPS module 106, the Wi-Fi module 108, the processor 110, the database 112, the battery 114, and may also incorporate additional operational components. In some embodiments, the location determination is based upon operation of the cellular module 104, the GPS module 106 and/or the Wi-Fi module 108 as discussed above.

The locator device 102 in system 100 is operable to communicate using the communication network 122. The communication network 122 may comprise one or more communication networks to facilitate communication with the locator device 102. For example, the communication network 122 may comprise a Wi-Fi communication which facilitates a broadband Internet connection. The communication network 122 may comprise one or more communication standards such as Internet communication, cellular communication, satellite communication, Bluetooth® communication, radio communication and/or other communication standards.

In some embodiments, the communication network 122 facilitates communication with a server 124. In some embodiments, the server 124 is in operable association with a database 126. As discussed above, the server 124 and the database 126 may be utilized during the location determination process. In some embodiments, the server 124 and database 126 may be utilized to track and/or analyze location information associated with the locator device 102. In some embodiments, the server 124 may create alerts based upon one or more characteristics of the locator device 102 operations and/or location information.

In this embodiment, the server 124 is operable to communicate with a second communication network 134. The second communication network 134 may comprise one or more communication networks such as an Internet connection in conjunction with a cellular communication. The second communication network 134 may comprise one or more communication standards such as Internet communication, cellular communication, satellite communication, Bluetooth® communication, radio communication and/or other communication standards. In some embodiments, the second communication network 134 is different from the communication used on the communication network 122. For example, the communication network 122 may comprise a cellular communication with the server 124 and the second communication network 134 may comprise an Internet communication.

In some embodiments, the server 124 creates an alert and provides the alert over the second communication network 134 to one or more networked monitoring devices, such as mobile phone 128, computer 130, tablet 132 and/or any other monitoring device, which are in operable association with the second communication network 134. In some embodiments, the server 124 may communicate over the second communication network 134 by sending a text, page, or other text based alert. In some embodiments, the server 124 only provides the alert to a selected monitoring device which is associated with the specific locator device 102. In some embodiments, the database 126 will maintain the associations between specific locator devices 102 and specific networked monitoring devices. In some embodiments, the server 124 will send different forms of the alerts over the second communication network 134 to different monitoring devices 128, 130 and 132. For example, the server 124 may send a text to the mobile phone 128, a status update to an application running on the tablet 132, and an email to the computer 130.

In some embodiments, the web interface provided by the server is accessible over the second communication network 134. In some embodiments, the web interface may be used to associate multiple locator devices 102, monitoring devices and/or other associated devices.

In some embodiments, some networked monitoring devices 128, 130 and/or 132 may be directly connected to the locator device 102 through communication network 122 and some networked monitoring devices 128, 130 and/or 132 may be indirectly connected to the locator device 102 through the server 124 and the second communication network 134.

In some embodiments, the various components and interfaces may include one or more security measures. For example, the web interface provided by the server 124 may include a password access system. In some embodiments, the server 124, the locator device 102 and/or the networked monitoring devices 128, 130 and 132 may require a series of identification and access protocols, such as device identification and associations electronically confirmed in conjunction with a password protection system. One skilled in the art will recognize that a variety of security measures and standards may be employed to protect access and/or control over the system 100.

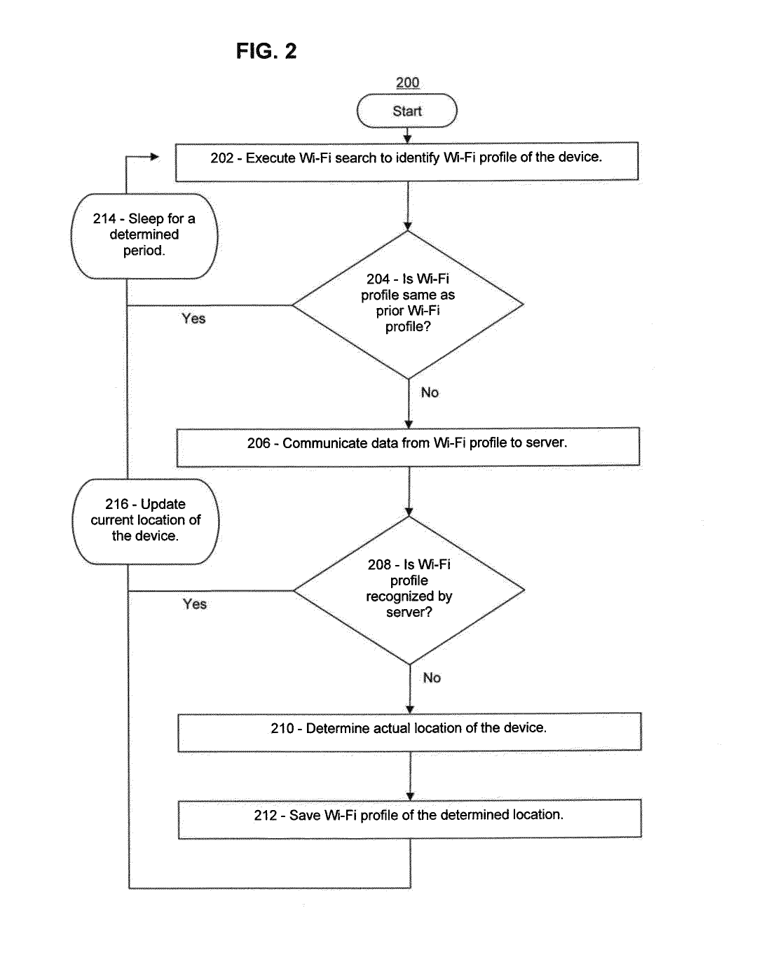

FIG. 2 a flowchart depicting an embodiment of a location determination process 200 of the present disclosure. In some embodiments, the steps of the process 200 may vary by removal of certain steps and/or the addition of other steps. In addition, the order of steps may vary in the operation of some embodiments. Certain variations may be disclosed herein while others are apparent from the disclosures provided herein. One skilled in the art will recognize that such variations remain within the scope and spirit of the present disclosure.

In the embodiment shown, the process 200 starts with box 202 wherein a device executes a Wi-Fi search to identify a Wi-Fi profile. The search may comprise any method of recognizing a Wi-Fi signal within range of a Wi-Fi module in the device and identifying the Wi-Fi source for the signal. The Wi-Fi profile may comprise one or more identified Wi-Fi sources within range for the Wi-Fi signal. In some embodiments, the Wi-Fi profile may also comprise signal strength information relating to each identified source. In some embodiments, other characteristics of the signal and/or Wi-Fi source may comprise a portion of the Wi-Fi profile. In some embodiments, the Wi-Fi search may identify one or more Wi-Fi signals to identify the Wi-Fi profile for a given location.

In some embodiments, the Wi-Fi search may determine that no Wi-Fi signals are available at a given location. When a Wi-Fi search determines that no Wi-Fi signal is available, the process 200 may follow alternative steps to those shown. For example, the device may automatically operate an alternative location determination component, such as an aGPS system, to evaluate the actual location of the device.

The process 200 further includes a determination box 204 which evaluates whether the determined Wi-Fi profile corresponds with the previously identified Wi-Fi profile. In some embodiments, the evaluation of whether the determined Wi-Fi profile corresponds with the previously identified Wi-Fi profile is utilized to indicate whether the device has moved or remains in the previously determined location.

If the Wi-Fi profile remains the same as the previously identified Wi-Fi profile, the device proceeds to box 214 to sleep for a period of time before restarting the location determination process 200. Under such circumstances, the consistent Wi-Fi profile indicates that the device has not moved significantly. The accuracy of the movement determination of the device may vary depending on the detail of the Wi-Fi profile information. For example, the movement determination may be more accurate when using signal strength information than a determination based only on identified Wi-Fi sources. In some embodiments, the process 200 may determine whether the device has moved based upon other mechanisms and/or attributes. For example, some device embodiments may include an accelerometer or other component to detect movement.

If the Wi-Fi profile is different than the previously identified Wi-Fi profile, the process 200 determines the new location of the device through one or more steps. In some embodiments, the device may evaluate whether the Wi-Fi profile is consistent with a known Wi-Fi profile which is associated with a known location. In some embodiments, the device may evaluate whether the Wi-Fi sources identified are associated with known locations, wherein the device can calculate an approximate location based upon the Wi-Fi profile. The analysis and/or evaluation may be conducted within the device, a server and/or another component in communication with the device.

In box 206, the device communicates data regarding the Wi-Fi profile identified by the device to a server or other third party component. For example, the device transmits the Wi-Fi profile to a networked server having a database or other storage component. In some embodiments, the device attempts to determine the location internally prior to transmitting the Wi-Fi profile the server. When the device determines the location, it may return to the sleep mode for a period as shown in box 214. If the device fails to identify a location, the device may proceed with sending the Wi-Fi profile to an external source for evaluation.

In determination box 208, the system determines if the Wi-Fi profile is recognized by the server and is associated with a known location. If so, the system updates the current location of the device to correspond with the known location of the Wi-Fi profile and returns to the sleep mode for a period as shown in box 214.

If the Wi-Fi profile is not recognized by the server, in box 210 the actual location of the device is determined. In some embodiments, the server may determine a location associated with the unknown Wi-Fi profile based upon location information associated with the Wi-Fi sources that comprise the unknown Wi-Fi profile. If the location may be determined based upon an evaluation of the Wi-Fi profile, the system updates the current location of the device to correspond with the determined location of the Wi-Fi profile and returns to the sleep mode for a period as shown in box 214.

In some embodiments, the location is determined through location determination components other than the Wi-Fi components. For example, the system may facilitate an aGPS determination of the actual location of the device. The server may interrogate the device to receive GPS data through the device and proceed to utilize additional information to determine an aGPS based location. For another example, the system may utilize a cellular triangulation system to determine the location of the device. In some embodiments, the selection of the location determination component may be based in part upon the power consumption of each potential location determination component. In some embodiments, the device may leverage other device capabilities when available to determine the current location of the device. For example, the device may utilize a Bluetooth® module to connect to a nearby GPS device and determine the current location based upon the location information received from the GPS device. In such an embodiment, the device may use less power through operation of the Bluetooth® communication than would be used for the device to utilize its own internal GPS components. In some embodiments, the location information received from the GPS device may comprise a location as determined by the GPS device. In some embodiments, the location information received from the GPS device may comprise GPS signal information which may be processed by the device or the associated server.

In box 212, the identified Wi-Fi profile is saved in conjunction with the determined location for the identified Wi-Fi profile. For example, the system may save the Wi-Fi profile and the determined location in a database associated with the server. The system may utilize the new saved information during future iterations of the process 200. This process may be utilized to develop a location database and improve the accuracy of determinations as additional information is loaded into the database.

In box 216, data regarding the current location of the device is updated in the system. In some embodiments, the data is updated in the server and/or the device storage. In some embodiments, the updating process may include determining if any alerts are applicable, posting the data on a web interface, providing visual updates depicting the current location of the device and/or other updates.

In box 214, the process 200 will sleep for a period of time to conserve battery. In some embodiments, the sleep period may be controlled by a web interface associated with the server. The sleep period may be variable based upon user controls and/or an evaluation of characteristics associated with the device, a monitoring device, defined monitoring zones and/or the system, such as time of day, day of the week, historical activity of the device, recent activity of the device, proximity to zone boundaries, current battery power and/or other characteristics. For example, at night the sleep period may be longer than during the active times of the day. For another example, the sleep period may decrease when the device is determined to be moving. For yet another example, the sleep period may change in proportion to the distance from the boundary, such as decreasing the sleep period as the distance to the boundary decreases.

At any point in the process 200, the device may communicate location information to another component, such as a central server and/or a monitoring component. In some embodiments, the device may limit communications based upon location data and/or other information to minimize power consumption. For example, the device may limit or eliminate communications when the device remains in the prior location. The device may also limit or eliminate communications based upon the current location remaining within the same zone as previously determined. The device may further limit communications when the battery charge is diminished. In some embodiments, the device may limit or eliminate communications when it detects another identified device within a given range. For example, the device may be associated with a monitoring device and eliminate communications when the associated monitoring device is within a given range.

In some embodiments, a group of devices may be associated with each other such that each device in the group may conserve battery by alternating communication between the devices within the group. In such an embodiment, the communication may indicate which group devices are within range. In addition, the system may trigger an alert if one or more of the devices separate from the group. In some embodiments, one communication device may be designated as the lead device to communicate with monitoring system components and to communicate with each of the devices to determine the range. In some embodiments, the lead device may be associated with a larger battery, additional processing components, additional output components and/or other components. For example, the lead device may include an RFID interrogator with a known range of communication in order to interrogate passive RFID components associated with each device associated with the lead device. If the RFID interrogator fails to receive a response from an associated device, the lead device may communicate the failure to other system components, utilize a wider range communication to communicate with the associated device, provide an alert to the user of the lead device and/or facilitate other operations to alert monitoring personnel and locate the associated device which exited the RFID range. In some embodiments, the lead device may include a display, speaker and/or tactile output.

For example, a school system may provide a group of locator devices to children attending a field trip. Each teacher or guardian may receive a lead device or monitoring device associated with a group of the children. Each locator device may periodically pair with the associated lead device or monitoring device to ensure the locator device is within the proper proximity. If one of the locator devices is outside of the proper proximity, the system may provide appropriate notifications and determine the current location of that locator device. One teacher or supervisor may have a monitoring device associated with all the locator devices, lead devices and monitoring devices on the field trip. In some embodiments, the school office may also have a computer set up to monitor the locator devices.

In some embodiments, the process 200 may implement and/or provide a user the ability to enable additional modes of operation to minimize battery consumption. For example, the process 200 may include an optional mode to evaluate movement using Wi-Fi profiles and delay operating any other communication components until the movement appears to have stopped. In such an example, following the determination that the current Wi-Fi profile is different than the prior Wi-Fi profile, the device may periodically continue to identify Wi-Fi profiles until consecutive determinations show the same Wi-Fi profile which indicates the device is not longer moving. After determining the device is no longer moving, the process 200 will continue to determine the current location of the device. In some embodiments, the period between identifying Wi-Fi profiles may be different from the sleep period between location determinations.

In some embodiments, thresholds associated with the movement determination may cause the device to determine a current location prior to determining the device is no longer moving. For example, an additional time period may be set such that the location will be determined at the additional time period even if the device is still moving. For another example, the device may be associated with a movement zone, whereby the device may use internal location determination information associated with the Wi-Fi profiles and predictive metrics to define a movement limit which will trigger a current location determination and communication with the system. As an example, the movement limit may be determined based upon the proximity between the prior location and the boundary of the movement zone and the movement time elapsed. In addition, successive Wi-Fi profile readings may be used to evaluate the speed of movement which may be associated with a threshold such as the movement zone and/or operated as an independent threshold to trigger a current location determination. With additional information, the system may also calculate directions of travel and/or other movement based information.

In some embodiments, the movement determination process is designed to conserve power. In some embodiments, the process may be used to track travel patterns using analytics to evaluate historical movement of the device and to build a database of Wi-Fi profiles. In some embodiments the Wi-Fi information collected during movement apart from location determinations may be less accurate than other means of associating locations with Wi-Fi sources. In some embodiments, the additional information may be leveraged to create better models of the Wi-Fi profiles and specific Wi-Fi sources.

In some embodiments, other embodiments of process 200 may be used within a fixed system with known communications. For example, within an office environment, the facilities may be electronically mapped such that only the Wi-Fi elements of the process would be necessary to identify the location of the locator device. In addition, the device may be paired with the office Wi-Fi such that it is able to access the Wi-Fi to transmit information to the system without using the cell system. In such a system, the locator device may be used to monitor employee activity.

Embodiments for an airport or airline may offer to provide a locator device for kids, baggage or other people or travel items which may be monitored to ensure the person or item is on the correct flight or terminal. For example, the airline may provide locator devices to kids traveling without adult supervision. The airline may monitor the device to ensure the kid arrives at the correct terminal, is on the correct plane, properly transfers planes and arrives at the proper destination. The airline may also require that an adult provide certain information and/or identification before the kid will be allowed to leave the premises. For example, the adult may be required to have a paired electronic device. In addition, the airline may provide monitoring access to the parent or other persons associated with the kid's travel.

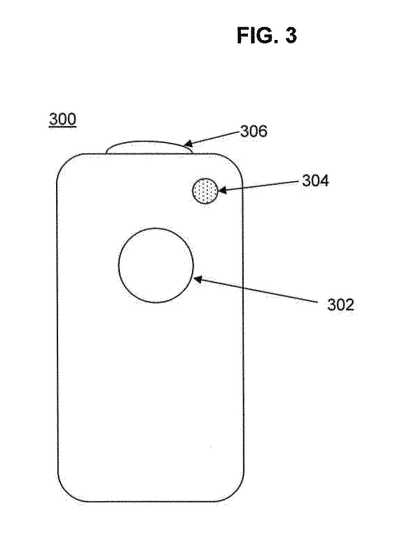

FIG. 3 depicts an embodiment of a locator device 300 of the present disclosure. The locator device 300 may include one or more of the components associated with the locator device 102 discussed in connection with system 100. In this embodiment, the locator device 300 includes a button 302, an output 304 and a support structure 306. The button 302 may operate one or more internal components of the locator device 300. In some embodiments, the button 302 may be removed and/or replaced with an alternative user interface component. For example, the button 302 may be removed so that the locator device 300 does not include a control or user interface feature. For another example, the button 302 may be replaced with a touch screen interface. For yet another example, the button 302 may be replaced with a microphone to allow voice activated controls. In some embodiments, the button 302 and the output 304 may be removed. For example, the button 302 and the output 304 may be removed in a pet tracking device, an integrated device, a concealed device and/or any other device in which user interface components may be unnecessary.

In some embodiments, the button 302 may be operated to control the location identification components. For example, actuating the button 302 may cause the location determination process to start. In some embodiments, the button 302 may operate as a panic button, wherein the locator device 300 determines the current location and generates an alert which is sent to a monitoring device. In some embodiments, the button 302 may operate as an alert or notification button, wherein the locator device 300 determines the current location and generates a notice of the current location which is sent to a monitoring device. For example, the user may press button 302 once to send a notification to inform a monitoring device of the arrival at a given location. In some embodiments, the notification signals may be associated with identified locations. For example, if the location identified by the locator device 300 is recognized by the system as an airport Wi-Fi, the system may notify the monitoring device that the user had arrived at the airport.

In some embodiments, the button 302 may be operated in different manners to control different aspects of the device. For example, a quick press of the button 302 may cause a test signal to be sent to confirm network access, two immediately successive presses of the button 302 may operate as a panic indicator, and pressing and holding button 302 may cause the locator device 300 to determine location using a high accuracy component, such as the GPS components, instead of the default process. In some embodiments, various operations may be controlled by other mechanisms built into the locator device 300, such as a second button, a knob, a switch, a motion sensitive control and/or another mechanism.

In some embodiments, actuating the button 302 as a panic button will trigger an alternative system operation. For example, the location determination may be automatically updated, and the default or selected sleep period may be reduced and/or eliminated. In some embodiments, the reduction in the sleep period may be maintained for a limited amount of time. For example, the device may enter a panic mode where the ten (10) minute selected sleep interval is reduced to a 30 second interval for five (5) minutes. In some embodiments, the system may communicate with one or more monitoring devices to enable the monitoring device to stop or continue the panic mode operation beyond the default panic mode period. In some embodiments, during the panic mode, the locator device is accessible to receive communication, controls, updates and/or additional information from the system. In some embodiments, the system may facilitate communication with emergency personnel.

In some embodiments, the output 304 is a light emitting diode (LED) or other light source which may be used to give a visual output indicative of various operations and/or status information. For example, the LED may provide a steady light during a location determination process, it may blink quickly to indicate that the device is outside a defined zone, and it may flash slowly to indicate the battery has dropped below a threshold charge. In some embodiments, the output 304 may comprise a series of colored LEDs which may indicate different operations based upon the color output. In some embodiments, the output 304 may comprise one or more audible outputs, such as a speaker, a piezoelectric device, and/or other audible outputs. In some embodiments, the output 304 may be concealed within the locator device 300. For example, a tactile or mechanical output, such as a vibration component, may be contained within the locator device 300. In some embodiments, the output 304 comprises one or more visual, audible, tactile and/or other sensory output. In some embodiments, the locator device 300 may not include any output 300.

In some embodiments, the locator device 300 includes a support structure 306 which may be used to facilitate attachment of the locator device 300 to a person, pet and/or object which will be tracked. For example, the support structure 306 may comprise a loop or hook which may be attached to a chain necklace of a person or collar for a dog. For another example, the support structure 306 may comprise a clamp which may be attached to clothing of a person or an object. One skilled in the art will recognize that the support structure 306 may comprise any means of attachment which does not interfere with the operation of the locator device 300, such as an adhesive, hook and loop tape, friction connections, bolts, screws, cotter pins, magnets, clasps and/or other means of attaching the locator device 300 to the desired object, pet or person. In some embodiments, the support structure 306 will facilitate integration of the locator device 300 with other objects, such as electronic devices, mobile phone components, vehicles and/or other objects.

In some embodiments, the locator device 300 includes internal controls in the hardware, firmware and/or software to extend battery life of the locator device 300. In some embodiments, the battery life is extended through component operation controls to limit the drain on the battery as discussed elsewhere herein. In some embodiment, the operation of the battery life may be extended through one or more charging controls associated with the battery charge system. For example, the firmware of the locator device 300 may provide for a reduced charging current which may extend the overall life of the battery across multiple uses and recharging cycles. For another example, the firmware of the locator device 300 may provide for an increased temperature tolerance which may allow the battery to accept an increased charge capacity and last longer for each use.

In some embodiments, the locator device 300 includes an internal antenna to facilitate communications. In some embodiments, the antenna is at least partially wrapped around the locator device 300.

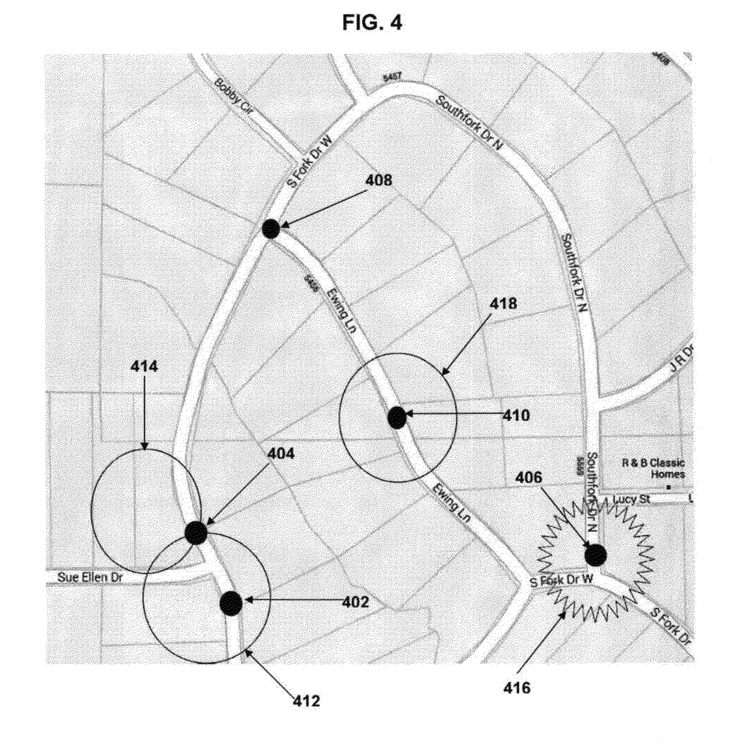

FIG. 4 provides a map illustration for discussion of the operation of the system and method of the present disclosure. The map includes exemplary device locations 402, 404, 406, 408 and 410, and exemplary communication zones including known Wi-Fi zones 412, 414 and 416 and an unknown Wi-Fi zone 418. The Wi-Fi communication is discussed for illustrative purposes; however, the illustrative Wi-Fi zones may represent any type of limited range communication, such as Bluetooth®, or limited rage components of a larger communication network, such as cellular towers which are independently associated with a limited range although multiple cellular towers facilitate a broad communication network. In some embodiments, the various zones may reflect different communication network references. In some embodiments, the zones may vary in size and shape depending on multiple factors, including signal characteristics, such as strength and frequency, geographic and/or man-made obstructions, noise from other signals and/or other factors.

In some embodiments, the device, such as the locator devices 102 and 300 discussed elsewhere herein, operates to mitigate battery usage and drain by prioritizing communication processes based in part on the battery consumption of the communication components. For example, if a device includes components for Wi-Fi communication, cellular communication and GPS communication, the device may prioritize the Wi-Fi communication over cellular and GPS communication and cellular communication over GPS communication. Although this example is discussed herein for illustrative purposes, one skilled in the art will recognize that the prioritization may vary based upon the included components and the state of the art for each component. In addition, the system may alter the priority based upon factors other than the battery consumption of components. For example, the system may elevate accuracy over battery consumption when the battery has a sufficient charge and the location is out of a defined zone. As another example, a server associated with the system may utilize historical data to analyze the area proximate to the current location of the locator device and determine that locating a Wi-Fi signal is unlikely, and therefore bypassing the Wi-Fi component would likely conserve battery consumption in spite of the power consumption profiles of the Wi-Fi components and the GPS components.

When the device is at location 402, the Wi-Fi components of the device will identify the Wi-Fi zone 412, which, for illustrative purposes, is the same zone in which the device was previously located. During the location determination process, upon identifying the Wi-Fi zone 412 the device will compare the identified Wi-Fi zone 412 to the prior Wi-Fi zone to evaluate whether the device has moved. Based upon this illustration, the Wi-Fi zone has not changed, therefore the device will return to a sleep mode for a given period or until another trigger causes the device to reevaluate the current location.

When the device is at location 404, the Wi-Fi components of the device will identify the Wi-Fi zones 412 and 414 as a Wi-Fi profile associated with the device. Upon identifying the Wi-Fi profile based on zones 412 and 414, the device will compare the identified Wi-Fi profile to the prior Wi-Fi profile to evaluate whether the device has moved. In some embodiments, the identification of Wi-Fi zone 412 which is consistent with the prior Wi-Fi profile comprising Wi-Fi zone 412 will lead to the determination that the device is within the same zone and the device will return to a sleep mode. In some embodiments, the analysis will consider the entire Wi-Fi profile. For example, based upon the identified Wi-Fi profile of zones 412 and 414, the comparison will determine the device has moved from the Wi-Fi zone 412 into a profile made of two Wi-Fi zones. Based upon the determination the device has moved, it may internally determine whether the new Wi-Fi profile is associated with a known location or a location may be determined based upon locations associated with the locations of Wi-Fi sources that create Wi-Fi zones 412 and 414. If the location is known or is determined, the device updates its current location and resumes the sleep mode. In some embodiments, the update is transmitted to another system component via a communication network. For example, the update may be transmitted to a remote server via a cellular communication network. In some embodiments, the update may be held in a queue to transmit upon an external request, in conjunction with another update transmission, as part of a batch update, and/or upon crossing a threshold.

When the device is at location 406, the Wi-Fi components of the device will identify the Wi-Fi zone 416 as the Wi-Fi profile associated with the device. Upon identifying the Wi-Fi profile based on zones 416, the device will compare the identified Wi-Fi profile to the prior Wi-Fi profile to evaluate whether the device has moved. The analysis determines the device has moved from the Wi-Fi zone 412 into Wi-Fi zone 416. Based upon the determination the device has moved, it may internally determine whether the new Wi-Fi zone 416 is associated with a known location. If the location is unknown, the device may use a cellular (or other communication) to access another system component to evaluate if the identified Wi-Fi zone 416 is known by the other system component. For example, the device may transmit information identifying the Wi-Fi zone 416 over the cellular network to a server. The server may evaluate whether the Wi-Fi zone 416 is associated with a known location and, if it is known in the server, updates the current location information associated with the device. In some embodiments, the server maintains the current location information associated with the device without providing an update to the device. In some embodiments, the server sends an update to the device. Upon a determination by the server, a signal may be sent to instruct the device to enter sleep mode. In some embodiments, the device may enter sleep mode if the server does not send any other instructions within a threshold timeframe. For another example, the device may communicate with other locator devices within a near-field communication range to determine if the Wi-Fi zone 416 is associated with a known location within memory of any local locator devices. If the location is recognized, the device may update the current location information and enter the sleep mode.

When the device is at location 408, the Wi-Fi components of the device will determine that no Wi-Fi zone is identified. Upon a determination that no Wi-Fi profile is present, the device will proceed with the next location determination mechanism. For example, the device may operate the GPS components to collect ephemeris and/or other GPS signal data and determine a GPS location. In some embodiments, determining the GPS location comprises transmitting the collected GPS signal data to a computer associated with a cellular tower which utilizes additional location information to improve the accuracy of the GPS location determination. The computer may transmit the GPS location information to the device and/or one or more other components of the system, such as a central server, a monitoring device or other devices. In some embodiments, the device may enter sleep mode upon sending the GPS signal data to the computer. In some embodiments, the device will remain accessible until a response from the computer or other system component is received. In some embodiments, the device remains active until a threshold factor is reached or surpassed, such as returning to a known location, a time period has elapsed, and/or another factor is reached or surpassed. In some embodiments, multiple factors may be combined to reach a collective threshold wherein any one factor may not be sufficient to meet the threshold for that factor alone. Once the location is determined, the system updates the current location information associated with the device. In some embodiments, the server maintains the current location information associated with the device without providing an update to the device. In some embodiments, the server sends an update to the device.

When the device is at location 410, the Wi-Fi components of the device will identify the Wi-Fi zone 418 as the Wi-Fi profile associated with the device. Upon identifying the Wi-Fi profile based on zones 418, the device will compare the identified Wi-Fi profile to the prior Wi-Fi profile to evaluate whether the device has moved. The analysis determines the device has moved from the Wi-Fi zone 412 into Wi-Fi zone 418. Based upon the determination the device has moved, it may internally determine whether the new Wi-Fi zone 418 is associated with a known location. If the location is unknown, the device may use a cellular (or other communication) to access another system component to evaluate if the identified Wi-Fi zone 418 is known by the other system component. If the other component does not recognize the Wi-Fi zone 418, the component communicates data indicating the need for further location information to the device. Following the receipt of such data, the device will proceed with the next location determination mechanism. For example, the device may operate in conjunction with another system component to determine an aGPS location associated with the device. In some embodiments, the other system component operates to determine the aGPS location in order to minimize battery consumption on the device. The aGPS location may be transmitted to the device and/or one or more other components of the system, such as a central server, a monitoring device or other devices. Once the aGPS location is determined, the system updates the current location information associated with the device and creates an entry associating the Wi-Fi zone 418 with the determined location. In some embodiments, the server maintains the current location information associated with the device without providing an update to the device. In some embodiments, the server sends an update to the device. In some embodiments, the device stores the new identified Wi-Fi zone 418 in order to conduct movement determinations as discussed above. Following the analysis and updating, the device will enter a sleep mode as described above.

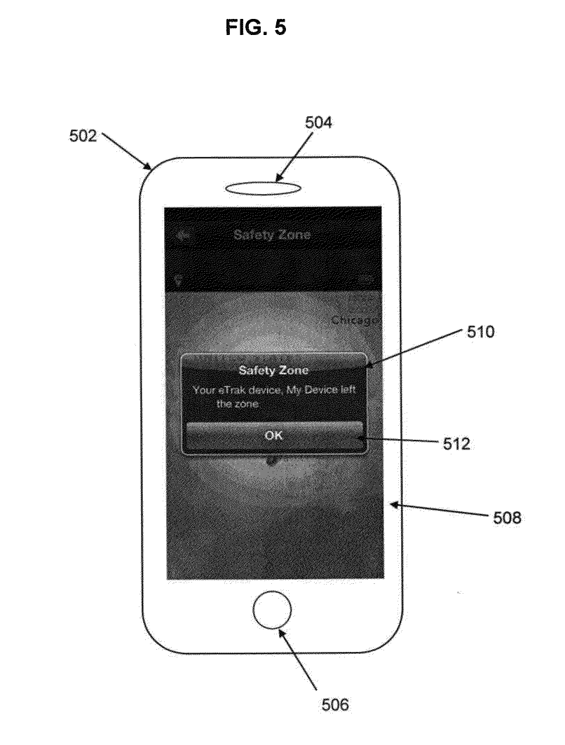

FIGS. 5 through 12 depict an embodiment of a monitoring device. In the embodiment shown, the monitoring device is depicted as a phone 502 having a speaker 504, a button 506 and a display 508. In some embodiments, the monitoring device may be a tablet, a computer, a custom monitoring device, a display device and/or any other device capable of operating as a monitoring device. One skilled in the art will recognize that the discussion herein regarding the monitoring device as the phone 502 is applicable to any other monitoring device capable of the operations disclosed.

The speaker 504, the button 506 and the display 508 of the phone 502 operate as user interface components. The various user interface components may be modified and remain within the scope and spirit of the present disclosure. For example, the button 506 may be removed allowing the user to control the phone 502 only through voice controls and/or touch screen capabilities associated with display 508. In some embodiments, the user interface may comprise other components, such as knobs, sensors, tactile interface components, visual outputs, optical analysis components, touch screen components and/or other user interface features. For illustrative purposes, the display 508 will be discussed as a touch screen components. One skilled in the art will recognize that the same system controls may be facilitated using a non-touch screen display and other user interface input controls.

In this embodiment, the phone 502 may employ application software to facilitate operations of a server, monitoring components, locator devices and/or other components or features of the system. The application software may be downloaded using any number of methods for loading software on a device. The software may be stored and/or transferred using a tangible computer program product. In some embodiments, the application software for the monitoring device may be the same as the locator device software. In some embodiments, the application software and locator device software are designed to complement and/or coordinate with each other and with other components, such as a server facilitating communication and analysis for the system.

Each figure further depicts an embodiment of an operations screen shown on display 508. The operations screens provided herein are for illustrative purposes and should not be construed as restrictive. In some embodiments, the operations screens shown herein may be replaced, deleted, modified and/or additional screens may be included.

In FIG. 5, the display 508 depicts an embodiment of a notice screen. In some embodiments, the notice screen includes a notice window 510 which appears in the foreground of the display. In some embodiments, the notice window 510 may appear elsewhere in the screen. In some embodiments, only an output in the display or otherwise will indicate that a notice is available upon selection using the user interface. In some embodiments, the appearance of the notice window 510 may vary based upon one or more factors. For example, the notice window 510 may become red and flash when the device leaves a safety zone during unexpected hours based upon user inputs defining the zones, relevant time periods, and alert levels. For another example, the notice window 510 may be diminished when the device leaves a safety zone at the expected time and is traveling towards the next expected safety zone. In some embodiments, the system will utilize historical analytics, predictive analysis, and/or user inputs to automatically determine the alert level and corresponding output for the notice window 510.

In this embodiment, the notice 510 provides an indication that the monitored locator device has left a safety zone. In some embodiments, the safety zone may be a predefined area assigned to the device. In some embodiments, the safety zone is variable based upon factors determined by user inputs and system analytics. In some embodiments, the safety zone is associated with another system component wherein the safety zone may move concurrently with the locator device. For example, if the safety zone is associated with the phone 502, the notice window 510 will only appear if the distance between the devices meets and/or surpasses a given threshold, such as the Wi-Fi communication range of the phone 502. In some embodiments, the safety zone may be defined based upon the range of a stationary Wi-Fi communication device, such as a home's Wi-Fi router.

In the embodiment shown, the notice window 510 includes a control button 512. When the user selects the control button 512, the notice window 510 may disappear and return the phone 502 to the operation screen or other activity occurring at the time the notice window 510 was created. In some embodiments, the control button 512 may direct the phone 502 to another operation screen, such as a map showing the locator device location. In some embodiments, the notice window 512 may include multiple control options, whereby the user may select to return to the prior activity or check on the locator device activity.

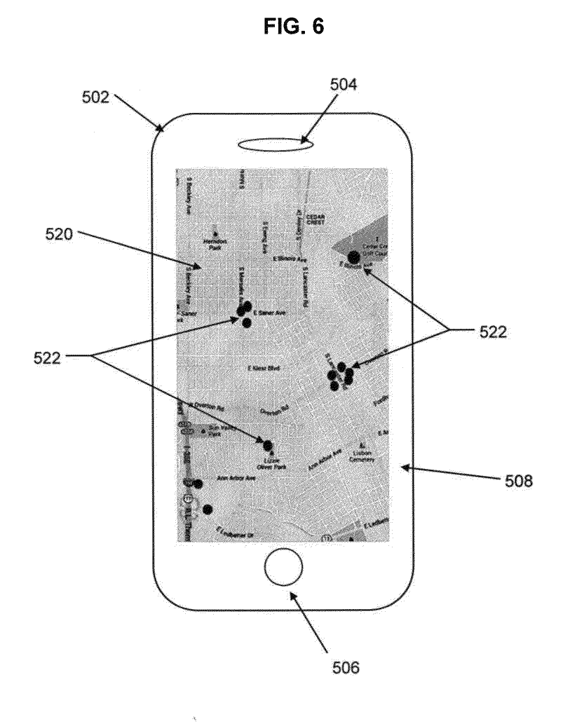

FIG. 6 depicts the phone 502 with the display 508 showing an embodiment of a map 520 with historical references at location points 522. In some embodiments, the map 520 showing device history may be accessed through the user interface controls. In some embodiments, the location points 522 may be activated to show additional information associated with that location point 522. For example, clicking one location point 522 may cause a window to appear showing the address, arrival time, departure time, visit count, links to additional information regarding the location (such as store website or property ownership information) and/or any additional information associated with that location. In some embodiments, the map may include a feature to show the path of travel by connecting the location points 522 according to time information associated with each point. In some embodiments, variation in the visual appearance of the location points 522 may indicate additional information regarding the location points 522, such as time, association with safety zones, areas of concern, panic indications and/or other information.

In some embodiments, the location points 522 may be filtered according to one or more characteristics. For example, a user of the phone 502 may restrict the location points 522 to those occurring within a given time frame. As another example, the user may elect to see the prior ten (10) location points 522 within a specific map segment or area. For yet another example, the system may display only location points 522 which were outside of a defined zone. The filters and/or elective options for controlling the location points 522 included in the map 520 may vary and remain within the scope and spirit of the present disclosure.

In some embodiments, the system may analyze the historical information illustrated on map 520 to determine patterns of conduct. For example, the system may determine that a patient at a hospital with a locator device is regularly sneaking away to binge on items that are detrimental to their health. For another example, system may determine that a child is repetitively visiting the library to study on the way home from school. In some embodiments, the system may suggest additional zones or alerts based upon the analysis of historical data. In some embodiments, the system may predict additional alerts based upon a history of locations which lead to panic alerts or other alerts. In some embodiments, the history information illustrated on map 520 may be used to backtrack in order to search for lost or missing items.

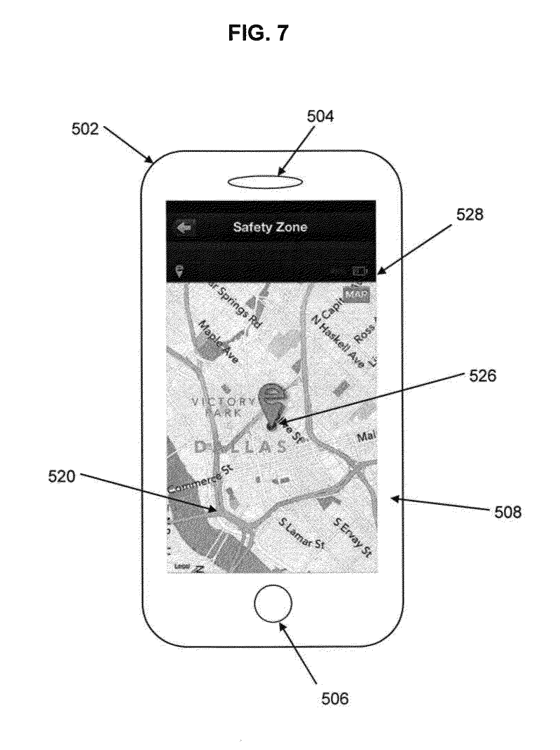

FIG. 7 shows the phone 502 displaying another embodiment of the map 520. In this embodiment, the map 520 shows the current location of the device at current point 526. In some embodiments, the current location is identified with an icon or other indicator. In some embodiments, the display may alter the icon for the current point 526 in appearance, such as change colors, based upon the status of the locator device. The status may be based upon one or more factors or characteristics, such as the current location information, proximity to a defined zone, battery capacity and/or other characteristic. Similar to the historical location points 522 discussed above, the current point 526 may be associated with a user interface control whereby additional information associated with the location and/or the locator device is provided. For example, if the icon for the current location 526 is pressed, a window showing links about the location may open wherein the user may determine more information regarding the whereabouts of the device and the potential risk of such location. In some embodiments, the system may determine that the location of the locator device is not likely appropriate and automatically alert a monitoring user of the information indicating the impropriety of the location. For example, if the locator device is associated with a minor and the current location is an alcoholic beverage store, the system may alert the parent or other monitoring user associated with the locator device.

In addition to the current point 526, the display screen includes a battery capacity indicator 528 in a header section of the display. Embodiments of the battery capacity indicator 528 may include a visual icon, a numerical representation and/or other indicator reflective of the status of the battery capacity. In some embodiments, the display may alter in appearance, such as change colors, based upon the battery capacity.

In some embodiments, the map 520 may depict a plurality of locator devices associated with the phone 502. The display may include icons for each current point 522 associated with each locator device and may provide battery capacity indicators 528 for each locator device. Each icon and battery capacity indicator 528 may be shown with a different appearance, such as color, design or other appearance characteristic, to indicate the different locator devices. For example, the first locator device may be indicated by a checkered icon and battery capacity indicator 528 and the second locator device may be indicated by a striped icon and battery capacity indicator 528.

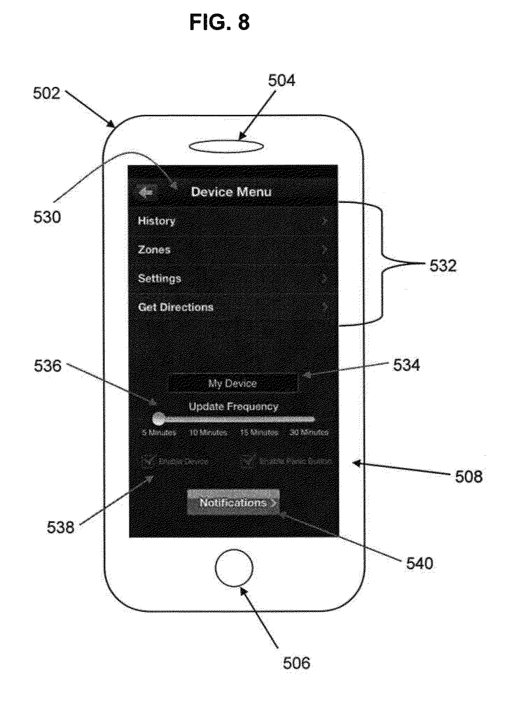

In FIG. 8, the phone 502 is depicted with an embodiment of a device menu illustrating potential controls and options. In this embodiment, the display 508 shows a header 530 indicating the current screen is a device menu and including a button to return to another screen. In some embodiments, the device menu relates to a single locator device. In such an embodiment, the application software may provide different device menus for each device associated with the phone 502. In some embodiments, a device menu may be associated with a plurality of devices, wherein the controls may be varied to reflect the plurality of associated locator devices.

This screen also shows a series of button controls 532 to select additional application pages which may be accessed, such as a History page, Zones page, Settings page, Get Directions page and/or other application pages. The number and mechanism for accessing any pages within the application may vary and remain within the scope and spirit of the disclosure. In some embodiments, the button controls 532 may include connections to pages for a plurality of devices and/or specific device pages.

In this embodiment, the display 508 further depicts a device button 534 which may direct the application to information regarding a selected locator device associated with the phone 502 and the current device menu page. In some embodiments, the device button 534 may direct the application to a table associated with the associated device, a map showing the current and/or historical locations of the locator device, status information regarding the locator device and/or other information.

The display 508 for this embodiment also shows an update frequency slide control 536. In some embodiments, the slide control 536 is used to select the sleep period for one or more associated locator devices. Upon a change to the update frequency using the slide control 536, the phone 502 communicates the update to the associated locator device(s) and/or to an intermediate component. In some embodiments, the update is held in a queue until the associated locator device(s) becomes active and is accessible via a communication standard. For example, the phone 502 sends the frequency update to a system server over the Internet. The server maintains the update in a queue until a communication is received from the associated locator device. Upon receipt of the communication from the locator device, the server sends the update to the associated locator device which updates its internal sleep period. In some embodiments, the system is designed for the server, phone 502 and/or other control device to activate a locator device which is in a sleep mode. In some embodiments, the locator device is inaccessible due to the communication components being shut down to conserve battery consumption.

In some embodiments, the device menu includes toggle controls 538 which allow selection of operation controls and indicate the current status of the feature. For example, the device menu may allow the user to enable or disenable the associated locator device(s). As another example, the device menu may allow the user to enable or disenable a panic button of the associated locator device(s). In some embodiments, the toggle controls may be used to facilitate other control and monitoring features of the phone 502 and/or the locator device(s).

In addition, this embodiment shows a notification button 540. In some embodiments, the notification button 540 may be used to open a notifications window in the display 508. In some embodiments, the notification button 540 may cause the application to output audible notifications using the speaker 504.

In some embodiments, the controls and/or outputs of the device menu may be rearranged, modified, replaced, removed and/or other controls may be added. For example, the application may utilize voice controls to navigate the menu options and application features. In some embodiments, the elements of the device menu illustrated in FIG. 8 may be implemented across multiple application pages.

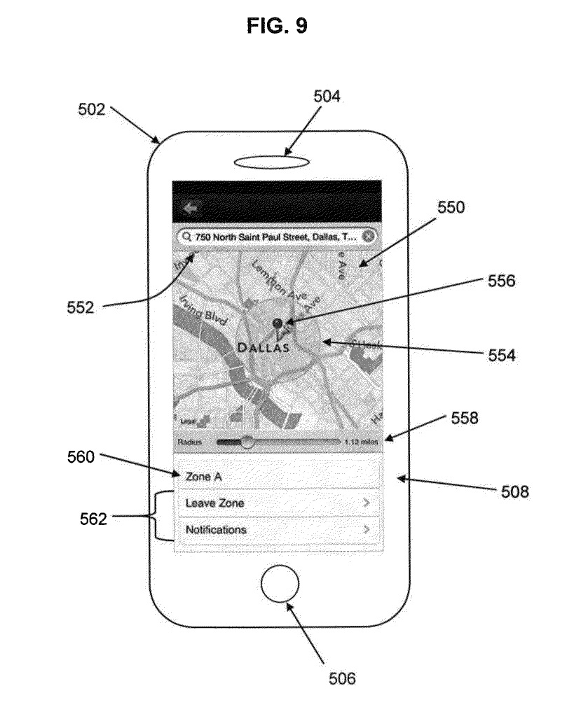

FIG. 9 shows the phone 502 showing a zone control screen in display 508. The screen includes a map 550 associated with a search conducted in the search bar 552. In some embodiments, the map 550 may be determined and/or searched using alternative mechanisms. For example, when initiating this application page, the map 550 may correspond with the location associated with the phone 502 and/or the associated locator device. For another example, a user may utilize map controls to zoom and move the map 550 until the desired location is shown.

In the embodiment shown, a zone 554 is shown around the identified location indicated by location icon 556. In this embodiment, the location icon 556 is shown as a pin. The location icon 556 may be represented by any number of designs, shaped, points and/or other appearances. In this embodiment, the zone 554 is shown as a circle. Embodiments of the zones associated with the system disclosed herein may vary in shape, size, basis (such as around a location, another device, a Wi-Fi range, etc.) and/or other characteristics.

The embodiment further shows a slide control 558 to define the desired radius of the zone 554 around the location icon 556. In some embodiments the slide control 558 may be proportioned to the depicted radius of zone 554. In some embodiments, the slide control 558 may provide radius information based upon the current selection of the slide control 558. In some embodiments, the slide control 558 may be replaced with other controls to set the radius of the zone 554, such as selectable distances, a text input option and/or other controls.

This embodiment further depicts a box 560 to provide a custom name to the defined zone 554. In some embodiments, the zone name may be provided by the system as a default name, an address, a property identifier and/or another name. In some embodiments, the system may provide optional names which may be selected to associate with the zone 554. In some embodiments, the application provides alternative input mechanisms to create zone names, such as text input features, voice commands, software uploads from other devices and/or other input mechanisms.

In addition, the display 508 includes additional buttons 562 which open additional application controls regarding the operation of the zone 554. For example, one of the additional buttons 562 may provide options to alert based upon leaving the zone, entering the zone, both leaving and entering the zone and/or alternative alert commands. One of the additional buttons 562 may provide additional notification controls, such as defining where and how the alert notifications are provided.

In some embodiments, the application software may provide certain controls associated with setting up zones which are different from controls provided through a web portal or other access means. For example, the application software may facilitate application of notifications specific to phone 502, while the web portal provides additional controls relating to the applicable time periods for alerts and associated alert levels based upon additional characteristics. Embodiments of the application software and web portal software may provide overlapping, alternative controls and/or additional collective control options.

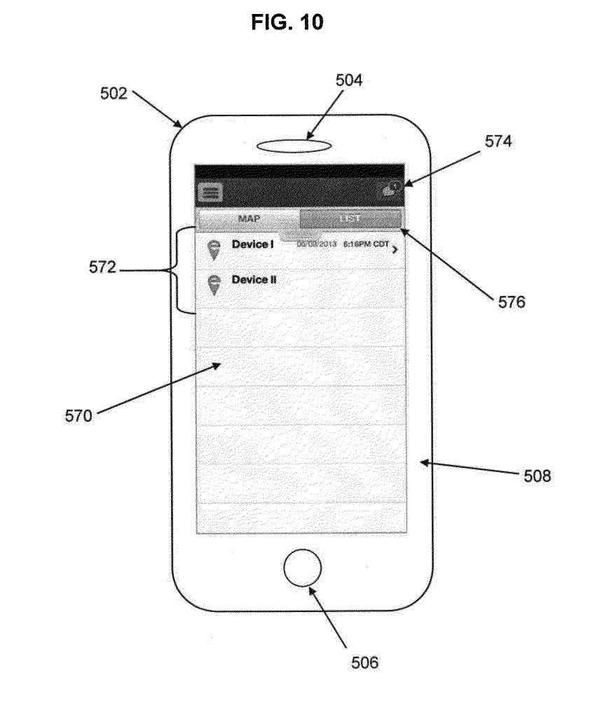

FIG. 10 depicts the phone 502 showing an embodiment of a device list 570. In this embodiment, the device list 570 includes device buttons 572 each associated with a different locator device. In some embodiments, the device buttons 572 may be used to link to additional information regarding the operation of each locator device, such as history of the device, monitoring statistics, device analytics, device battery charge, control analytics and/or additional information. In some embodiments, the device buttons 572 may include additional information on the button itself such as a device name, information regarding the most recent activity of the device and/or additional information.

This embodiment further shows a notification icon 574 which indicates that an unread notification is associated with at least one locator device associated with the phone 502. In some embodiments, the notification icon 574 is also a button that opens a window showing the relevant notification(s). In some embodiments, the notification icon 574 may be associated with a map view to associate the notification with a specific location. In some embodiments, the map view may include directions from the phone 502 to the location of the locator device.

In addition, the screen includes a switch control 576 to select between the list view shown and a map view depicting the locations of the various devices. In such an embodiment, the icons indicating each device may operate as buttons to connect to the additional information associated with the device.

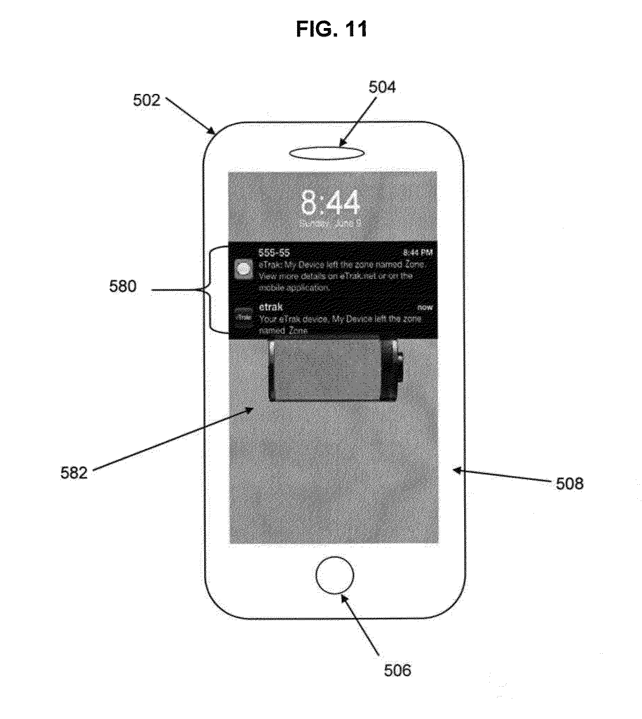

FIG. 11 depicts the phone 502 with another embodiment of a screen showing exemplary alert messages 580. The alert messages 580 show one text message and one application message illustrating variations in potential alert messages. In some embodiments, only one message is communicated to the phone 502. In some embodiments, both messages are communicated to the phone 502 to provide redundancy to ensure the phone 502 receives the message. In some embodiments, the user may select how the phone 502 receives alert messages. For example, the user may enable the text messages during one time frame, application alerts during a second time frame, both text and application messages during a third timeframe and an alternative alert for a fourth timeframe.

In the embodiment shown, the screen also provides a battery charge indication 582 for the locator device and/or the phone 502. In some embodiments, the battery charge indicator 582 may provide an estimated time remaining for the average and/or anticipated usage of the device. The application may also provide controls to further manage the battery consumption based upon an anticipated usage and charging schedule.

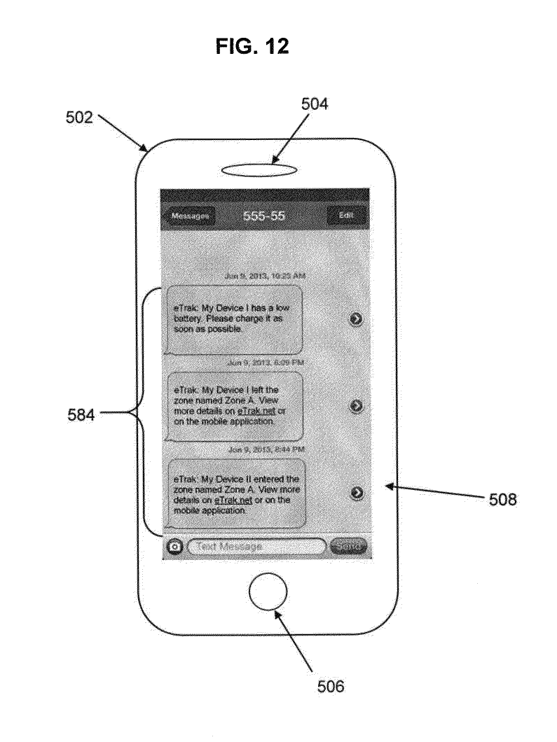

FIG. 12 depicts the phone 502 with another embodiment of a screen showing exemplary text messages 584. The text messages 584 illustrate potential alert messages and or notifications. For example, the text messages 584 may notify the user of phone 502 that the locator device has a low battery, alert the user of phone 502 that the Device 1 has left Zone A and alert the user of phone 502 that Device 2 has entered Zone A. In some embodiments, the text messages 584 may be associated with links to additional information and/or application pages.

In some embodiments, the user of phone 502 may control the types of text messages 584 the phone 502 receives. For example, the user of phone 502 may enable alert messages for leaving certain locations during defined time periods, such as leaving school during the class times. For another example, the user of phone 502 may enable battery charge alerts based upon battery capacity of the locator device falling below 15%. In addition, the user of phone 502 may disable alerts for the device entering a mobile zone associated with phone 502.

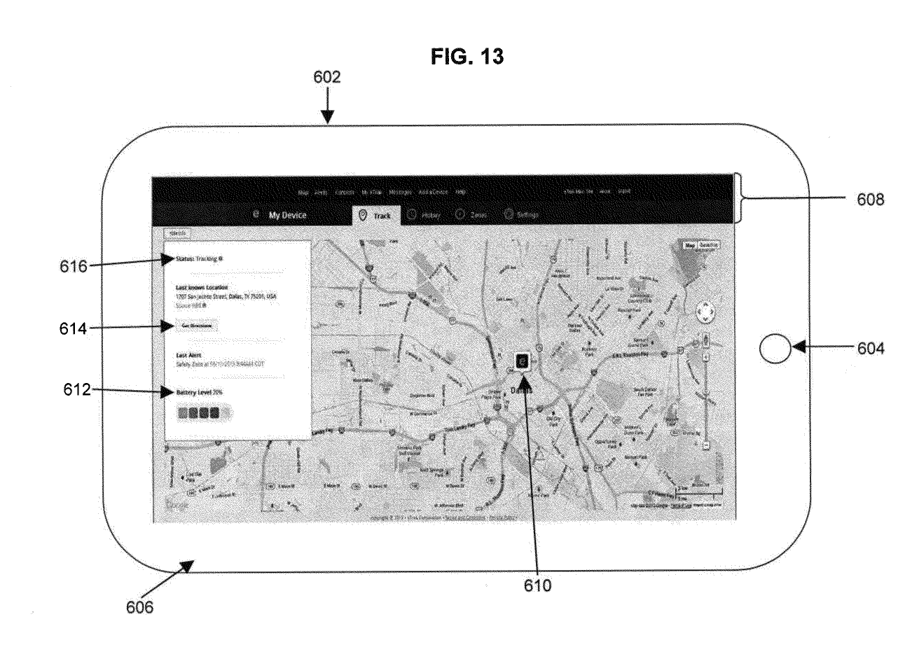

FIGS. 13 through 17 depict another embodiment of a monitoring device. In the embodiment shown, the monitoring device is depicted as a tablet 602 having a button 604 and a display 606. In some embodiments, the monitoring device may be a phone, a computer, a custom monitoring device, a display device and/or any other device capable of operating as a monitoring device. One skilled in the art will recognize that the discussion herein regarding the monitoring device as the tablet 602 is applicable to any other monitoring device capable of the operations disclosed.

The button 604 and the display 606 of the phone 602 operate as user interface components. The various user interface components may be modified and remain within the scope and spirit of the present disclosure. For example, the button 604 may be removed allowing the user to control the tablet 602 only through voice controls and/or touch screen capabilities associated with display 606. In some embodiments, the user interface may comprise other components, such as knobs, sensors, tactile interface components, visual outputs, optical analysis components, touch screen components and/or other user interface features. For illustrative purposes, the display 606 will be discussed as a touch screen components. One skilled in the art will recognize that the same system controls may be facilitated using a non-touch screen display and other user interface input controls.

In this embodiment, the tablet 602 is depicted operating a web portal associated with the system of the present disclosure. In some embodiments, the tablet 602 may use a website, virtual private network, remote connection and/or any other network system to remotely connect to a server in communication with the locator device and providing control options for the system operation. In some embodiments, the tablet 602 may operate as the monitoring device and the system server and/or database.

In some embodiments, the tablet 602 may employ application software to facilitate operations of a server, monitoring components, locator devices and/or other components or features of the system. The application software may be downloaded using any number of methods for loading software on a device. The software may be stored and/or transferred using a tangible computer program product. In some embodiments, the application software for the monitoring device may be the same as the locator device software. In some embodiments, the application software and locator device software are designed to complement and/or coordinate with each other and with other components, such as a server facilitating communication and analysis for the system. In some embodiments, the application software for the tablet 602 may differ from application software for alternative monitoring devices.

Each figure further depicts an embodiment of screens shown on display 606. The screens provided herein are for illustrative purposes and should not be construed as restrictive. In some embodiments, the screens shown herein may be replaced, deleted, modified and/or additional screens may be included.

FIG. 13 shows the tablet 602 operating a web portal associated with the present disclosure. In this embodiment, the screen shown in display 608 includes a header section 608 which includes optional page selections. In some embodiments, the header 608 may include links to additional pages, tabs which allow different page views and information, and/or any additional controls. In some embodiments, the header 608 may provide information regarding the web portal, the monitoring device, one or more locator devices, the server status, location information and/or other information. In some embodiments, the header 608 may include one or more notifications, alerts and/or warnings.

In this embodiment, the screen also includes a map showing a device location 610. The device location 610 represents the most recent position identified through the location determination process of the system associated with the locator device. In some embodiments, the map may include a plurality of device locations 610 representing locations associated with a plurality of locator devices associated with the tablet 602.

In some embodiments, the system will pair specific locator devices and specific monitoring devices with an account through the web portal. For example, a server may maintain paring information within a database which associates devices with monitoring devices for purposes of alerts, warnings, notifications, device management, monitoring access and/or other purposes. In some embodiments, different monitoring devices will be associated with different levels of access, control, alerts and/or other purposes. For example, one monitoring device may be associated with a locator device to receive alerts and notifications, but is not operable to manage the operations of the locator device. Another monitoring device may be associated with management and control features associated with operations of the locator device. In some embodiments, monitoring devices may be directly paired independent of a server or intermediate component. For example, location information associated with a locator device may be encrypted whereby only the paired monitoring device is designed to decipher the encrypted location information.

The screen embodiment shown also depicts a box with additional information associated with the locator device. The additional information in this embodiment includes a battery status 612, a directions button 614 and a current status indicator 616. The information box also includes the last known address information and the last alert provided. Embodiments of the system may include additional information and/or a modified selection of information which may replace, delete and/or otherwise alter the information options provided. In some embodiments, the content of the information box may be based in part upon user selections. In some embodiments, the information box may provide information regarding a plurality of locator devices. In some such embodiments, the information box may include one or more controls to select which locator device information is displayed. In some embodiments, the system determines which locator device information is displayed based upon an analysis of the locator devices. For example, the default information may be associated with the one or more devices which are not in a defined zone or are in the incorrect zone. For another example, the default information may be provided based upon the battery capacity of the locator device.

The battery status 612 is shown as a visual indicator with a numerical representation of the current battery capacity of the locator device. One skilled in the art will recognize that the battery status 612 may be visually depicted in a variety of manners and remain within the scope and spirit of the present disclosure. In some embodiments, the battery status 612 may show the anticipated life of the battery for the locator device. In some embodiments, the battery status 612 may be operable as a link to open a window with additional information regarding the battery status 612 such as the last charge time, charge success, analytics regarding degradation of the battery capacity and/or any other information regarding the battery.

In some embodiments, the directions button 614 may be used to access geographical directions from the tablet 602 to the current location of the locator device as shown at device location 610. In some embodiments, the system may be set up to provide directions to another monitoring device, such as the monitoring device with the closest proximity to the locator device.

In some embodiments, the status indicator 616 shows an operational status associated with the locator device, such as tracking, sleeping, charging and/or other locator device operations. For example, the status indicator 616 may show the system is currently tracking the location of the locator device. For another example, the status indicator 616 may show the locator device is currently in a sleep interval. Embodiments of the status indicator 616 may also indicate when the locator device is in active communication with the system for other reasons, such as a panic mode, a Wi-Fi location update, a device software update and/or another communication purpose.

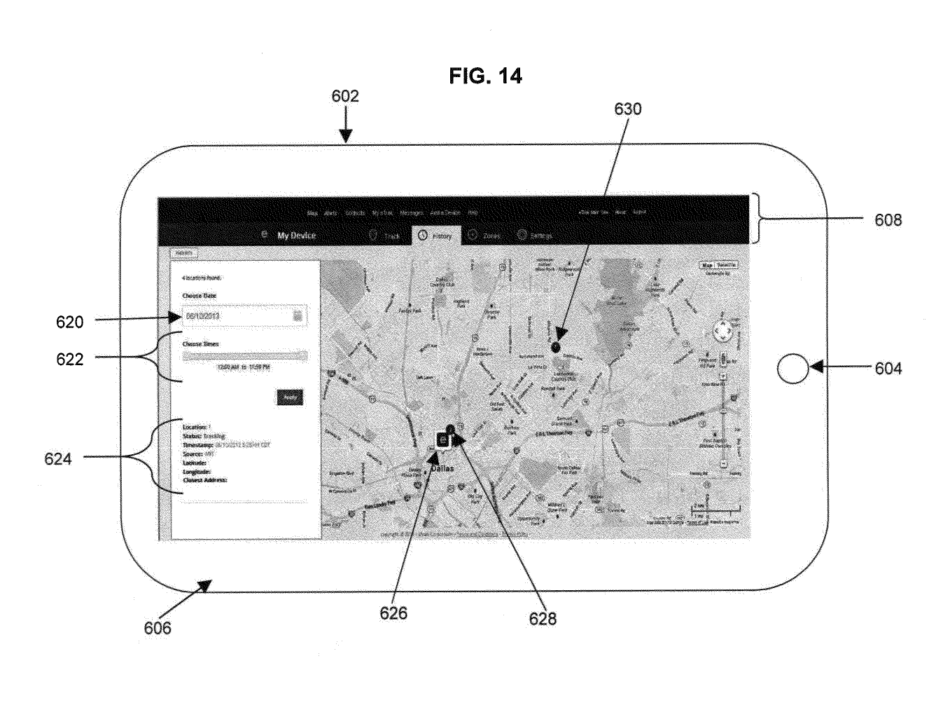

FIG. 14 depicts tablet 602 showing an embodiment of a screen for the history tab selected in this embodiment of header 608. This embodiment includes control features for the history page in the information box to the side. The control features shown include a date selection 620 and timeframe selection 622. In some embodiments, the features provided may include alternative, replacement and/or an otherwise altered selection features. For an example, the features may include a location based history page wherein the user may define a geographic area and the map will depict the past twelve (12) entries in the defined area. The icons for the prior entries may be shown in different appearances to reflect the age of the entry.

In the embodiment shown, the date selection 620 may accept text inputs and/or using a calendar selection feature to identify the date of interest. In some embodiments, the date selection 620 may accept additional inputs, such as voice or selection inputs, to indicate a selected date for the history page to show. For example, the date selection 620 may provide a series of date specific buttons to select a given date from those provided. In some embodiments, a plurality of dates may be selected using the date selection 620. Embodiments of the date selection 620 may allow a user to select a range of dates, a series of related dates (i.e. the past four Fridays) and/or another collection of dates.

In the embodiment shown, the timeframe selection 622 is a slide control with two slides to define the timeframe between the slides. The two slides may be used to select a given timeframe for the history results. For example, a parent may look at the history of locations during the school hours for a child. In some embodiments, multiple ranges may be set for the timeframe selection 622. For example, another parent may look at one hour blocks of time before and after the school day. As with the date selection 620, the control features and operations associated with the timeframe selection 622 may vary and remain within the scope and spirit of the present disclosure.

In some embodiments, the date selection 620 and timeframe selection 622 may be utilized to review a pattern of historical conduct. For example, an employer may select the prior six Fridays between 8 a.m. and 5 p.m. to see the where an employee is stopping every Friday during work hours.

In the screen shown, status information 624 provides information regarding the recent location, activity and alert information associated with the locator device. In some embodiments, the information may be modified to reflect more information, less information, and/or alternative information. In some embodiments, the status information 624 and the history information may pertain to a plurality of locator devices. In some embodiments, the associated locator devices may be selectable for inclusion or exclusion using one or more controls.

In addition, the map shows the recent location point 626 in addition to the historical location points 628 and 630. In this embodiment, the recent location point 626 is depicted with one type of icon while the historical location points 628 and 630 are shown with an alternative icon. In some embodiments, the historical location points 628 and 630 may include information and/or appearances which indicate the order and/or age of historical location points 628 and 630. In some embodiments, the defined zones associated with the locator device may be overlaid on the map. In some embodiments, the appearance of the recent location point 626 and/or the historical location points 628 and 630 may indicate the level of warning, level of alert, panic locations, locations out of defined zones and/or additional information. As discussed elsewhere herein, the points may also be selectable to provide additional information.

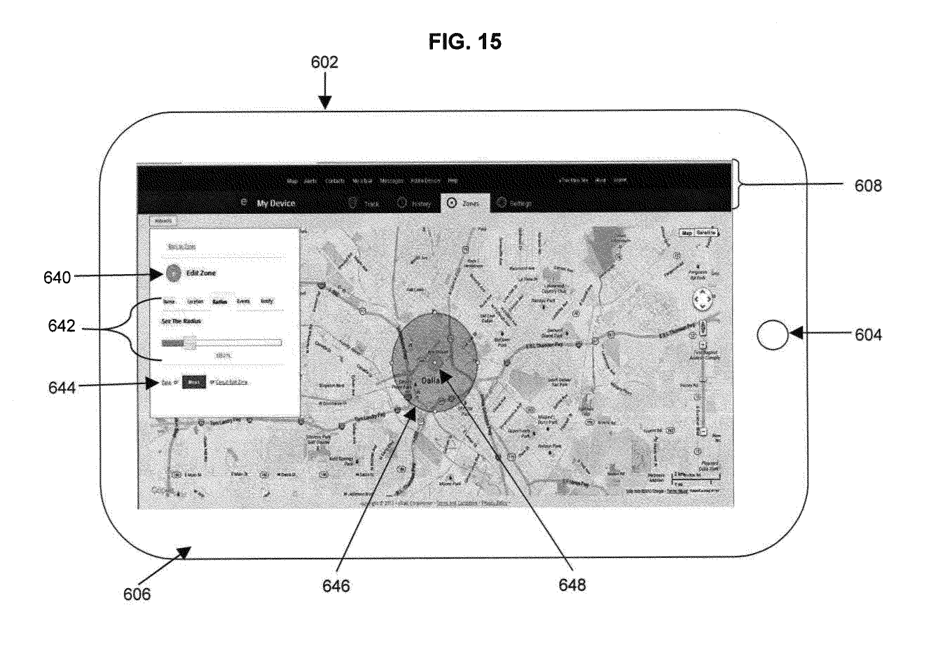

FIG. 15 depicts tablet 602 showing another embodiment of a screen on display 606. In this embodiment, a zones tab is selected in the header 608. The screen depicts part of the process for setting up and/or editing a zone. The zone status indicator 640 provides an indication of the purpose of the screen, such as to edit the zone, review the zone characteristics and/or other purposes. Editing the zone for this embodiment includes selecting attributes of the zone including the name, the location, the radius, the event triggers and the notification instructions. Each of these attributes are available options through selecting a tab under the zone status indicator 640.

In the present screen, the radius tab is selected. In some embodiments, the selection of the radius tab is dependent upon identifying a location under the locations tab. Under the radius tab in this embodiment is a slide control 642 for editing the radius for the zone around a given location. In addition, the screen shows tab controls 644 for navigating through the zone setup and editing tabs. The tab controls 644 also provide for canceling the current actions. In some embodiments, the tab controls 644 and/or tabs include additional controls relating to the setup and editing of a zone, display options and/or additional options.

The map shown in the present embodiment also depicts an illustration of the zone 646 centered on the zone location 648 which illustrates the central point in this embodiment. The illustration of the zone 646 may vary as the controls are altered. For example, the illustration of the zone 646 may change in conjunction with the movement of slide control 642. In some embodiments, the zone 646 may be manipulated through map controls using the touch screen capabilities of the display 606. If the zone 646 size is altered using the map controls, the radius indicated by slide control 642 may reflect the change to the size of zone 646. In some embodiments, map controls associated with the zone 646 may facilitate other modifications to the zone 646 which are not available using other control components.

In some embodiments, the zone 646 may be an alternative shape, such as a rectangle, ellipse, octagon, or any other shape. For example, the zone 646 may be defined as a rectangle around a selected residential street. One skilled in the art will recognize that the controls to define alternative shapes may vary and remain within the scope of the present disclosure. For example, the web portal may provide a shape selection and corresponding slide controls associated with one or more dimensions of the shape. In some embodiments, the zone 646 may be drawn using a freeform mechanism, a point connection mechanism and/or any other mechanism to facilitate the creation of a defined shape for zone 646. For example, the system may include a mechanism to allow a user to select the locations of interest intended to be within a given zone and the system will create a zone 646 of a sufficient shape to encapsulate the selected locations. In such an example, the user may select dimensions associated with one or more select locations to ensure the boundary is customized to the user input. In some embodiments, the tabs may include additional control options to facilitate the implementation of different shapes for zone 646.

In some embodiments, the map may be enable to display other zones associated with the locator device, history of the locator device and/or other location information associated with the area, the locator device, the monitoring device or other locator devices. For example, the user may intentionally define a focused zone 646 for a minor alert level, but further define a larger zone, which incorporates the area of zone 646, for a heightened alert level. For another example, the user may define zone 646 to coordinate with a common historical location associated with the device.

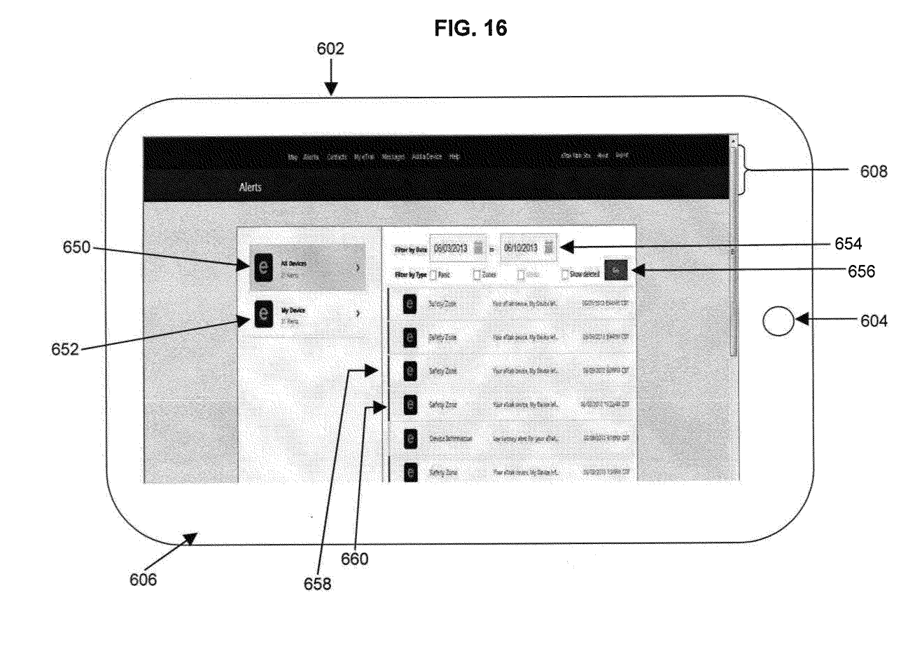

FIG. 16 depicts tablet 602 showing another embodiment of a screen on display 606. In this embodiment, an alerts page shown including the header 608. The screen depicts a listing of alerts for locator devices associated with the tablet 602. In the embodiment shown, the first device selection 650 allows for alerts relating to all devices to be provided, and the second device selection 652 may allow the list to be filtered to only include alerts associated with the selected device. Embodiments of the system may allow for filtering based upon any one or more associated locator devices.

In some embodiments, the alert list may also be filtered by a date range selector 654. In this embodiment, the dates may be entered into the date range selector 654 using text inputs, voice inputs, button selections, calendar selection windows and/or other inputs. In some embodiments, the filters may include timeframe selections in addition to the date range selector 654. As discussed herein, the operations, controls and features of the date range selector 654, any timeframe selector and/or any other time filter may be implemented and remain within the scope and spirit of the present disclosure.

In some embodiments, the alert list may include toggle filters 656 to allow a user to enable or disable other selectable filters. In some embodiments, the toggle filters include the ability to filter by panic button alerts, zone alerts, alert levels, alert responses and/or other filters associated with one or more potential alerts.

The alert list shown in this embodiment also includes alert entries 658 and 660. The alert entries 658 and 660 may provide information regarding the locator device, the alert type, the alert content, the time of the alert, the location of the alert, the alert level and/or other relevant information associated with the alert. In some embodiments, certain information may be indicated with variations in appearance. For example, each locator device may be associated with a different icon or picture, such as a picture of the pet with which the locator device is associated. For another example, the alert level may be indicated with a different color associated with each alert entry 658 and 660. In some embodiments, additional information may be accessed using a control option associated with each alert entry 658 and 660. In some embodiments, the user may select the information which is shown and the information which must be accessed through control options.

In some embodiments, the alert page may depict and/or provide access to additional analytical information. For example, the system may analyze the data collected from one locator device and determine patterns of conduct associated with the single locator device. For another example, the system may collectively analyze data associated with multiple devices to determine patterns of conduct associated with the multiple devices. In some embodiments, the analysis may be limited to devices associated with the tablet 602. In some embodiments, the analysis may reflect generic analytic determinations regarding associated and unassociated devices.

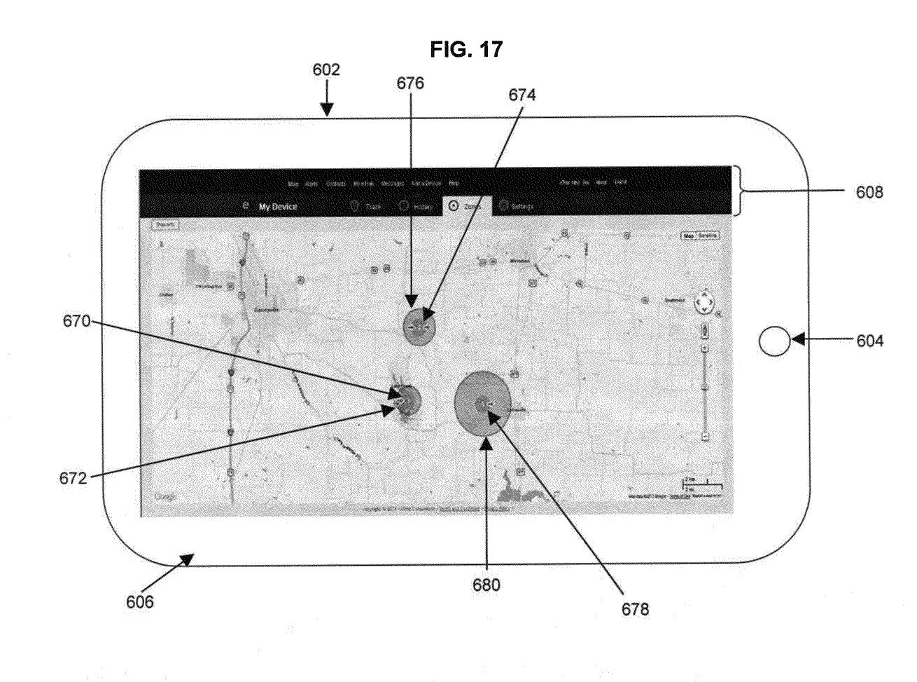

FIG. 17 depicts tablet 602 showing another embodiment of a screen on display 606. In this embodiment, a zones tab is selected in the header 608. The screen depicts a map showing existing zones associated with one or more locator devices associated with the tablet 602. In this embodiment, the zones include a first zone 670 located around a first location 672, a second zone 674 located around a second location 676 and a third zone 678 located around a third location 680. In the view shown, the zones 670, 674 and 678 illustrate certain aspects about each zone. For example, the size of each zone is depicted, wherein the first zone 670 is shown with a small radius, the second zone 674 is shown with a medium sized radius and the third zone 678 is shown with a large radius. In addition, each zone in this embodiment includes one or more arrow operating as an indicator of the alert trigger associated with the zone. For example, the first zone 670 includes an arrow pointing to the first location 672 which indicates that the alert will be triggered when the locator device enters the first zone 670. The second zone 674 includes an arrow pointing to the second location 676 which indicates that the alert will be triggered when the locator device enters the second zone 674 and an arrow pointing away from the second location 676 which indicates that the alert will be triggered when the locator device leaves the second zone 674. The third zone 678 includes an arrow pointing away from the third location 680 which indicates that the alert will be triggered when the locator device leaves the third zone 678.

In some embodiments, the zones 670, 674 and 678 may include additional visual indicators to provide information regarding the zones 670, 674 and 678 to the user of tablet 602. For example, zone identifiers may be included such as pictures, symbols and/or other indicators. For another example, alert levels associated with each of zones 670, 674 and 678 may be reflected using various colors.

In some embodiments, additional information may be accessible through user controls associated with each of the zones 670, 674 and 678 and/or locations 672, 676 and 680. For example, pressing the zone 670 may open a window providing information regarding the zone, such as time spent in the zone, entries into the zone or other information, and controls allowing the user to access the editing features of the system, the alert list associated with the zone and/or other control and information pages.

The invention being thus described and further described in the claims, it will be obvious that the same may be varied in many ways. Such variations are not to be regarded as a departure from the spirit and scope of the invention and all such modifications as would be obvious to one skilled in the art are intended to be included within the scope of the apparatus, system, process and computer program product described.

1. A device tracking system comprising:
a tracking device comprising:
a battery operable to provide power to said tracking device,
a location determining module which is operable to determine a location associated with the tracking device,
a communication module which is operable to communicate with a system network, and
a processor operatively associated with said location determining module and said communication module, wherein said processor of said tracking device determines said location associated with said tracking device through said location determining module and communicates location information to said system network;
a tracking zone analysis component which determines whether said location associated with said tracking device is within a predefined tracking zone associated with the tracking device; and
a networked monitoring component comprising:
a network communication module for communicating with said system network, and
an output component operable to provide tracking information to a monitoring user, wherein said tracking information is based on at least one of said location associated with said tracking device and the determination of said tracking zone analysis component.

2. The system of claim 1 wherein said location determining module comprises a plurality of location determining components which are prioritized based upon power consumption associated with each of said plurality of location determining components.

3. The system of claim 2 wherein said plurality of location determining components comprise a Wi-Fi communication module operable to determine location based upon an identified Wi-Fi profile which is associated with a previously identified location, a GPS module and a cellular module operable to determine location based upon cellular identification.

4. The system of claim 2 wherein said communication module is operable as one of said plurality of location determining components.

5. The system of claim 1 wherein said tracking zone analysis component is integrated with at least one of said tracking device, said networked monitoring component, and a networked system server.

6. The system of claim 1 wherein said output component provides an alert based upon a determination by said tracking zone analysis component that said location associated with said tracking device is not within said predefined tracking zone.

7. The system of claim 1 wherein said output component provides an alert based upon a determination by said tracking zone analysis component that said location associated with said tracking device indicates that said tracking device entered said predefined tracking zone.

8. The system of claim 1 wherein said tracking zone is a geographical area.

9. The system of claim 1 wherein said tracking zone is based upon a Wi-Fi source.

10. The system of claim 9 wherein said tracking zone is further based upon a signal strength associated said Wi-Fi source.

11. The system of claim 1 wherein said tracking zone is based upon a Wi-Fi profile, wherein said Wi-Fi profile comprises a plurality of Wi-Fi sources.

12. The system of claim 1 wherein said tracking zone is dependent upon at least one of a time, a day, a historical analysis and a movement characteristic.

13. The system of claim 1 wherein said tracking zone is manageable through a user interface associated with said networked monitoring component.

14. The system of claim 1 wherein said output component of said networked monitoring component depicts a map.

15. The system of claim 14 wherein said map depicts at least one of said location associated with said tracking device, a historical location associated with said tracking device, a location associated with said networked monitoring component and said tracking zone.

16. The system of claim 1 wherein said tracking device determines said location associated with said tracking device based upon an action of a user of said tracking device.

17. The system of claim 16 wherein said tracking device comprises a user interface and said action comprises a user input through said user interface.

18. The system of claim 16 wherein said action comprises a user moving said tracking device at least one of into said tracking zone and out of said tracking zone.

19. The system of claim 1 wherein said tracking device determines said location associated with said tracking device based upon an action of said monitoring user.

20. The system of claim 1 further comprising a networked server operationally associated with said system network which comprises a memory component, wherein said memory component stores information received from said tracking device.

21. The system of claim 20 wherein said information received from said tracking device comprises a Wi-Fi identification associated with a geographic location.

22. The system of claim 21 wherein said networked server comprises an analysis component wherein said analysis component evaluates a plurality of said Wi-Fi identifications associated with a plurality of said geographic locations to determine a Wi-Fi map.

23. The system of claim 20 wherein said networked server facilitates a web portal, through which a managing user may manage operations of at least one of said tracking device, said server and said networked monitoring component.

24. The system of claim 1 comprising a plurality of said pre-defined tracking zones associated with said portable device, wherein said tracking zone analysis component determines whether said portable device is within one of said plurality of said predefined tracking zones and upon a determination that said portable device is within one of said plurality of said predefined tracking zones, identifies the predefined tracking zone within which the portable device is located.

25. The system of claim 24 wherein said output component provides alternate outputs based upon said determination of whether said portable device is within one of said plurality of said predefined tracking zones.

26. A tracking device comprising:
a battery operable to provide power to said tracking device;
a location determining module which is operable to determine a location associated with the tracking device;
a communication module which is operable to communicate with a system network; and
a processor operatively associated with said location determining module and said communication module, wherein said processor of said tracking device determines said location associated with said tracking device through said location determining module, determines whether said location associated with said tracking device is within a pre-defined tracking zone associated with the tracking device and upon a determination by said tracking zone analysis component that said location associated with said tracking device is not within said pre-defined tracking zone, communicates tracking information to said system network.

27. The device of claim 26 wherein said location determining module comprises a plurality of location determining components which are prioritized based upon power consumption associated with each of said plurality of location determining components.

28. The device of claim 27 wherein said plurality of location determining components comprise a Wi-Fi communication module operable to determine location based upon an identified Wi-Fi profile which is associated with a previously identified location, a GPS module and a cellular module operable to determine location based upon cellular identification.

29. The device of claim 27 wherein said communication module is operable as one of said plurality of location determining components.

30. The device of claim 26 wherein said tracking zone is a geographical area.

31. The device of claim 26 comprising a Wi-Fi communication module operable to identify a Wi-Fi source and wherein said tracking zone is based upon said Wi-Fi source.

32. The device of claim 31 wherein said tracking zone is further based upon a signal strength associated said Wi-Fi source.

33. The device of claim 31 wherein said tracking zone is based upon a Wi-Fi profile, wherein said Wi-Fi profile comprises a plurality of said Wi-Fi sources.

34. The device of claim 26 wherein said tracking zone is dependent upon at least one of a time, a day, a historical analysis and a movement characteristic.

35. The device of claim 26 wherein said tracking zone is manageable through a user interface associated with at least one of said tracking device, a networked monitoring component and a networked system server.

36. The device of claim 26 wherein said tracking device operates in a sleep mode between the determinations of said tracking zone analysis component.

37. A method for monitoring movement of a portable device comprising the steps of:
identifying a tracking zone associated with said portable device, wherein said tracking zone comprises a predefined area;
determining whether said portable device is within said tracking zone; and
upon a determination that said portable device is not within said tracking zone, communicating tracking information to a remote monitoring component, wherein said tracking information includes a location associated with said portable device, wherein said location is determined by a location determining module comprising a plurality of location determining components which operate in a prioritized order based in part upon a power consumption associated with each of said plurality of location determining components.

38. The method of claim 37 wherein determining whether said portable device is within a tracking zone comprises the steps of:
determining a geographic location of said portable device using said location determining module; and
comparing said geographic location of said portable device to a geographic area associated with said tracking zone.

39. The method of claim 37 wherein said predefined area comprises an area surrounding a zone signal source, and wherein determining whether said portable device is within a tracking zone comprises the steps of:
receiving a signal through a signal acquisition component;
determining a received signal source associated with said signal; and
determining whether said received signal source comprises said zone signal source.

40. The method of claim 39 wherein said zone signal source is at least one of a Wi-Fi signal source, a Bluetooth® signal source and a ZigBee® signal source.

41. The method of claim 39 wherein said zone signal source comprises a mobile signal source.

42. The method of claim 39 wherein said tracking zone is based upon a threshold signal strength, wherein said portable device is not within said tracking zone when said signal received by said signal acquisition component is below said threshold signal strength.

43. The method of claim 39 wherein said tracking zone comprises a plurality of predefined tracking zones, and said method further comprising the step of determining whether said portable device has moved tracking zones which comprises the steps of:
determining whether said portable device is within one of said plurality of predefined tracking zones;
upon a determination that said portable device is within one of said plurality of predefined tracking zones, identifying a specific predefined tracking zone within which said portable device is located; and
comparing said specific predefined tracking zone with a prior predefined tracking zone to determine whether said portable device has moved to a different tracking zone.
